SEQUENCE LISTING (7 sequences)

SEQ ID NO: 1 - DNA, 25 bp, Artificial Sequence
  peptide nucleic acid tag
nnnnnnnnnnnnnnnnnnnnnnnnn

SEQ ID NO: 2 - DNA, 25 bp, Artificial Sequence
  peptide nucleic acid tag
nnnnttttcttcnnnnttnttttnn

SEQ ID NO: 3 - DNA, 26 bp, Artificial Sequence
  peptide nucleic acid tag
cnnnnttttcttcnnnnttnttttnn

SEQ ID NO: 4 - DNA, 27 bp, Artificial Sequence
  peptide nucleic acid tag
cnnnnnttttcttcnnnnttnttttnn

SEQ ID NO: 5 - DNA, 26 bp, Artificial Sequence
  peptide nucleic acid tag
cnnnnttcttctcnnnntnttnttnn

SEQ ID NO: 6 - DNA, 26 bp, Artificial Sequence
  peptide nucleic acid tag
cnnkktctttctcnnnntntttntkk

SEQ ID NO: 7 - DNA, 26 bp, Artificial Sequence
  peptide nucleic acid tag
cnnnnttctcttcnnnnttntnttnn

(19) United States
(12) Patent Application Publication
(10) Pub. No.: US 2012/0283955 A1
(43) Pub. Date: Nov. 8, 2012

(54) METHODS FOR DATA MANIPULATION RELATING TO POLYMER LINEAR ANALYSIS

(75) Inventors: Douglas B. Cameron, Wellesley, MA (US); Gene Malkin, Brookline, MA (US); Nirupama V. Chennagiri, Billerica, MA (US); Sergey V. Fridrikh, Acton, MA (US); Ekaterina Protozanova, Arlington, MA (US)

(73) Assignee: Pathogenetix, Inc., Woburn, MA (US)

(21) Appl. No.: 13/407,537

(22) Filed: Feb. 28, 2012

Related U.S. Application Data
(60) Provisional application No. 61/447,444, filed on Feb. 28, 2011.

(51) Int. Cl. G06F 19/24

(52) U.S. Cl. 702/19

(57) ABSTRACT

The invention provides methods for the manipulation and processing of data from direct linear analysis of polymers such as nucleic acids. The resultant processed data is used to identify nucleic acids and/or their biological sources, and/or to identify mutations in the polymers.

### RELATED APPLICATIONS

This application claims the benefit of U.S. Provisional Application Ser. No. 61/447,444, filed on Feb. 28, 2011, entitled “METHODS FOR DATA MANIPULATION RELATING TO POLYMER LINEAR ANALYSIS”, the entire contents of which are incorporated by reference herein.

### FIELD OF THE INVENTION

The invention relates to data manipulation methods and devices and systems incorporating such methods as used in the linear analysis of polymers such as nucleic acids.

### BACKGROUND OF THE INVENTION

Nucleic acid analysis is the basis of a variety of research and medical therapies. Such analysis may take the form of nucleic acid sequencing (i.e., determining the order of nucleotides along the length of a nucleic acid), or it may involve obtaining sufficient information about a nucleic acid to allow comparison with other nucleic acids in order to determine likedness or degree of identity or disparity. This information may be used for example to establish distance between organisms or subjects on an evolutionary tree.

One way of obtaining information about nucleic acids (including sequence information) is through the binding (or hybridization) to a target nucleic acid (or pool of target nucleic acids) of nucleic acids of known sequence (referred to herein interchangeably as probes, tags, or unit specific markers). It is to be understood that, as used herein, probes, tags and unit specific markers bind to nucleic acid targets in a sequence-specific manner. The binding, under stringent conditions, of probes to a target nucleic acid yields information about the sequence of the target. In addition, the binding pattern for any given probe (i.e., a probe binding profile) or of any combination of probes (i.e., a combination probe binding profile) can be used to compare target nucleic acids in order to determine if the targets are identical to each other, if they derive from the same source, and/or the degree to which they are similar or dissimilar, among other things.

Linear analysis of nucleic acids means that the nucleic acids are analyzed in a linear manner, starting from one position, whether at a terminal position or an internal position, and moving linearly in one direction in order to obtain information.

Typically, the nucleic acids being analyzed are not cleaved or fragmented during the process of linear analysis, and instead they remain intact and can therefore be further manipulated and/or processed. They may however have been cleaved or fragmented prior to analysis to facilitate analysis. For example, the nucleic acids are more likely to be fragments of chromosomes rather than entire chromosomes themselves. Such chromosome fragments however may still be on the order of hundreds of kilobases in length.

### SUMMARY OF INVENTION

The invention provides a variety of methods for manipulating and analyzing raw data from a direct linear analysis of polymers such as nucleic acids. The methods may be used in a variety of combinations and order. In some embodiments, the polymers are nucleic acids labeled with (1) a sequence non-specific compound such as a sequence non-specific backbone stain and (2) a sequence-specific probe (or tag), which emit different signals. The sequence-specific probe may be a bisPNA. The nucleic acids being analyzed may be chromosomal fragments such as restriction chromosomal fragments.

The manipulations of the invention include intensity filtering, acceleration correction, and size or length correction. The invention further contemplates the use of iterative classification algorithms to determine similarity of an observed nucleic acid fragment (as represented by its intensity versus length/distance or its intensity versus time trace) to another fragment or to a standard (referred to herein as a template trace). Similarity to one or more other nucleic acids being analyzed allows a user to group nucleic acids. Similarity to a standard allows a user to identify the nucleic acid, its source and potentially any mutation it may harbor.

In one aspect, the invention provides a method comprising determining extent of similarity between an observed trace from an observed nucleic acid and each of a plurality of template traces, each template trace representing an average trace for a class of nucleic acids, and identifying the class of nucleic acids to which the observed nucleic acid belongs using a classification algorithm, wherein each trace is an intensity versus time trace or an intensity versus distance trace for a nucleic acid.

In some embodiments, the template trace is an average trace of a plurality of previously acquired traces. In some embodiments, the template trace is an average theoretical trace.

In some embodiments, the observed trace is from an observed nucleic acid labeled with a sequence non-specific backbone stain and a sequence-specific probe.

In some embodiments, the method further comprises, prior to determining extent of similarity, excluding observed traces having higher than expected intensities. In some embodiments, the method further comprises, prior to determining extent of similarity, excluding observed traces having higher than expected backbone stain intensities. In some embodiments, the method further comprises, prior to determining extent of similarity, applying an acceleration correction to the observed trace. In some embodiments, the acceleration correction is a correction that results in symmetry between head-first and tail-first observed traces. In some embodiments, the method further comprises, prior to determining extent of similarity, applying a stretching coefficient to the observed trace. In some embodiments, the stretching coefficient is determined using a standard nucleic acid of known length that is labeled with a sequence non-specific backbone stain only.

In some embodiments, the classification algorithm is a statistical model of expected distribution of photons measured along a target nucleic acid.

In some embodiments, the nucleic acid is obtained from a mixture of nucleic acids. In some embodiments, the mixture of nucleic acids is obtained from a mixture of pathogens.

In some embodiments, the nucleic acid is a restriction fragment. In some embodiments, the nucleic acid is about 50-500 kb in length. In some embodiments, the nucleic acid is about 100-300 kb in length. In some embodiments, the sequence-specific probe is a bisPNA.

The foregoing is an exemplary method provided by the invention. Various other inventive aspects and embodiments are described herein.

### BRIEF DESCRIPTION OF THE DRAWINGS

FIG. 1 provides a schematic of DNA linear analysis, including averaged unoriented traces and oriented head-first and tail-first traces.

FIG. 2 shows exemplary ways to present results and evaluation of nucleic acid sorting and comparisons.

FIG. 3 is a likelihood score versus fragment histogram.

FIG. 4 is an average log-likelihood versus fraction (%) histogram.

FIG. 5A shows ratio of probabilities (in logarithmic scale) that the data originated from nine different strains of E. coli. In this experiment we have measured the CFT073 strain and the identification algorithm points to the correct strain (the highest bar).

FIG. 5B shows the same ratio of probabilities recalculated “per molecule” (linear scale).

FIG. 6 shows an example of the length histogram and specific distance difference plot. In this example the distance difference plot illustrates that linear analysis data for two strains of E. coli W3110 and K12 is very similar everywhere except for the fragments with the length between 70 and 80 microns.

FIG. 7 shows the observed average traces for various strains superimposed on the theoretical traces (or templates) for these strains.

FIG. 8 shows the measured data from unsequenced SA113 sample being compared to 11 sequenced strains of S. aureus.

FIGS. 9A and B illustrate the similarity of certain fragments of SA113 (A: 160 kb; B: 179 kb) to theoretical NCTC8325 traces.

FIGS. 10A-C show the relative probability, represented as bar graphs, of a known strain being the source of an unsequenced observed strain (A: BID2; B: BID3; C: BID6).

FIGS. 11A-C show the traces of various BID2 fragment lengths (A: 197 kb; B: 189 kb; C: 123 kb) overlayed on the theoretical traces of corresponding fragments of MRSA252.

FIGS. 12A-E show the traces of various BID3 fragment lengths (A: 115 kb; B: 132 kb; C: 158 kb; D: 177 kb; E: 231 kb) overlayed on the theoretical traces of corresponding fragments of Mu50.

FIGS. 13A-D show the traces of various BID2, BID3 and BID6 fragment lengths overlayed on the theoretical traces of corresponding fragments of Mu50.

FIGS. 14A and B are optical maps (or traces) of bacterial artificial chromosome BAC 12M9 using a bisPNA probe carrying a single fluorophore at one end (A) or a bisPNA probe carrying a first fluorophore on one end and a second fluorophore at its center (B).

FIG. 15 is a table showing specifics of various probes.

FIG. 16 is a histogram showing binding of various probes to BAC12M9 match sites and SEMM sites when hybridization is carried out for 5 and 15 minutes.

FIG. 17 is a Kₒₙ versus type of PNA tag histogram showing that PNA probes display different kinetics determined by the total charge of the probe (PNA and fluorophore combined).

FIG. 18 shows the results of mapping of E. coli 536 monoculture with SanDI/p268A SG pair. Experimental maps are presented as average HF (solid) and iTF (dotted) traces. Theoretical traces (bottom traces) are calculated for 85% and 20% occupancies of match and SEMM sites, respectively; brightness of individual tag was set at 8 photons per bin. The abscissa represents the length of the molecule in kb; the ordinate represents average photon count per bin. Theoretical traces are offset for clarity.

FIG. 19 shows the results of mapping of E. coli O157:H7 Sakai monoculture with SanDI/p268A SG pair. See FIG. 18 description for detail.

FIGS. 20A and B show detection of a target microbe at low concentration in a complex bacterial mixture. The targets, E. coli and S. epidermidis, were present at 1 and 4% by DNA mass, respectively. (A) p-Value of detection for genomic DNA fragments of various species is depicted vs. relative quantity of molecules attributed to each fragment by classifying software (expressed as percentage of total number of analyzed molecules). Each dot corresponds to a DNA fragment of specific length from the DLA range. Smaller p-Value (higher position on the Y-axis) means higher confidence of detection. Only the fragments from the target organisms and the components of the background included in the data base exhibit significant confidence of detection: E. coli (square), S. epidermidis (star, asterisk), F. johnsoniae (triangle), V. fischeri (circle). (B) Total log-likelihood of microbe detection. Only 15 bacteria, which generated “hits” against the detected fragments, are presented.

The Figures are schematic and are not intended to be drawn to scale. For purposes of clarity, not every component is labeled in every figure, nor is every component of each embodiment of the invention shown where illustration is not necessary to allow those of ordinary skill in the art to understand the invention.

### DETAILED DESCRIPTION OF INVENTION

The invention relates broadly to data manipulation, processing and analysis methods as applied to linear analysis of polymers such as nucleic acids. The data are manipulated and processed in order to yield information about polymers including sequence information, whether at low or high resolution. Such information can be used to identify the source of a polymer or the relatedness of polymers to each other. The degree of similarity and/or difference between polymers can also be used to determine the source of a polymer. The ability to identify the source of one or more polymers in a sample can be used to identify the presence of a biowarfare agent, a genetically modified organism, an infectious agent such as a pathogen, or other polymer-containing agent in the sample being analyzed.

Many of the exemplifications described herein relate to polymers that are nucleic acids. However it is to be understood that the methods provided herein can be readily applied to analysis of other polymers including proteins, polysaccharides, and the like.

The methods provided herein are particularly useful and thus directed more specifically to data that can be represented by traces plotted on an intensity versus distance or time histogram. These traces can derive from individual polymers or they may represent the sum total of traces from a subset or complete set of polymers. In one of the contemplated analyses, single polymers are individually moved relative to an interrogation point (such as a laser spot), followed by detection of signal continuously or at discrete positions along the length of the polymer. The signal results from the interaction of the polymer (and/or substituents bound thereto) with the interrogation point. An example of this would be interaction of a nucleic acid with a laser that emits at a wavelength that excites fluorophores bound to the nucleic acid. The polymer may be in flow and the interrogation point may be fixed, or alternatively the polymer may be fixed and the interrogation point may be in motion. Regardless, the output from the analysis is a trace that represents the polymer (or a continuous region of the polymer).

The trace typically minimally reflects the relatively uniform binding of a sequence non-specific compound to the polymer throughout the region of polymer being analyzed. This is typically achieved through the use of a sequence non-specific backbone stain, in the case of nucleic acids. Sequence non-specific compounds bind to for example nucleic acids independent of nucleotide sequence.

The trace may also show signal from a second class of compounds bound to the polymer and importantly this second class of compounds provides sequence-specific information as compared to the backbone stains referred to above. It is important to distinguish the sequence-specific signals from the backbone stain signals, and this is typically achieved by using sequence-specific and sequence non-specific compounds that emit at different wavelengths relative to each other. The traces can then yield information about the presence or absence of sequence-specific signals and the relative position of such signals. Sequence-specific compounds, in the case of nucleic acids, are typically nucleic acid probes that bind specifically to a sequence of nucleotides, typically through complementary base pair hybridization. In order to emit signal, such probes are themselves attached to a detectable label such as a fluorophore.

Both the backbone stain and the detectable label are chosen so that they can interact with the laser, thereby giving rise to signals that are detected by detectors. Typically, each of the backbone stain and the detectable label is excited by the laser and emits signal that is distinguishable from the signal arising from the other. Two detectors would be required in this instance. If more than one probe is used and it is important to distinguish between the various probes, then three or more detectors may be necessary.

The system therefore detects the presence, absence and amount of signal at each of the detectors for any given time point of analysis or position along the polymer. The signal obtained from the backbone stain indicates the presence of a nucleic acid, since the nucleic acid is essentially uniformly labeled with backbone stain along its length. Thus, the presence of signal from the backbone stain indicates the presence of a nucleic acid in the interrogation point. Conversely, a time point in which there is no signal from a backbone stain indicates that no nucleic acid is in the interrogation point. Presence and absence of backbone stain signal therefore tracks with the presence and absence of a nucleic acid in the interrogation point.

Thus, in the context of polymers that are nucleic acids, the analysis methods described herein generally are applied to data that are a total of sequence-specific and sequence non-specific signals. Sequence-specific signals derive from labels (i.e., signal emitting compounds) that are associated (covalently or non-covalently) with probes. Probes are molecules that bind to a target nucleic acid based on the sequence of the target. In this way, the probes are said to bind in a sequence-specific manner. Nucleic acid probes generally bind to sequences that are complementary in sequence, as will be understood by those of ordinary skill in the art.

Other compounds bind to nucleic acids in a manner that is not dependent on the specific sequence of the nucleic acid and rather bind, preferably, relatively uniformly along the length of the nucleic acid. It is this latter binding that allows nucleic acids to be identified and discriminated from other random signals in a data set.

Sequence information may be high resolution information including for example continuous nucleotide sequence for extended stretches. Sequence information of lower resolution may also be useful for various applications including determining the identity and/or source of nucleic acids. This latter type of information may be obtained by analyzing the binding location(s) of one or more probes to target nucleic acids (i.e., the probe binding profile or pattern).

The following manipulations and algorithms can be applied to the observed linear analysis data. These manipulations and algorithms may be used individually or in combination.

### Filtering and Correction Algorithms

Intensity Filtering: In one aspect, the invention provides a method for identifying within a data set the presence of a polymer such as a nucleic acid, and preferably nucleic acids in usable conformations. In other words, this aspect of the invention is able to identify nucleic acids that are stretched out or “linearized”.

Data from linearized nucleic acids are distinguished from data deriving from nucleic acids that have some level of secondary structure such as one or more hairpins (e.g., at the ends), or that are associated with proteins, neither of which are usable. Stretched nucleic acids such as stretched DNA may experience relaxation at their ends or formation of hairpins, whether internal or terminal, thereby obscuring the true probe binding pattern. The signal resulting from a nucleic acid with secondary structure may suggest that a probe was bound to the nucleic acid at a particular location (i.e., because the end of the molecule which had one or more probes bound to it was folded over at that location), when in fact no probe was actually bound to the molecule at that location.

Nucleic acids that are bound to proteins (other than protein-based probes) can emit anomolously higher numbers of photons. The invention provides methods for identifying both types of nucleic acids and removing their respective traces from any subsequent analysis.

In some embodiments, a set of filters may be used to identify such nucleic acids, following which they may be disregarded and not processed any further. For example, a brightness filter may be used to detect traces from nucleic acids bound to proteins. Generally, imperfection in nucleic acid stretching (e.g., folded molecular ends) will result in a backbone trace having regions of intensity much higher than the median intensity. Backbone filters may be used to scan backbone traces for these regions and remove the corresponding traces and corresponding data. This technique dramatically decreases the chances of false positives and considerably simplifies and accelerates clustering of unknown nucleic acids (discussed in greater detail below).

Acceleration Corrections: In another aspect, the invention provides a method for correcting acceleration artifacts that can effect “perceived” probe binding profiles. Acceleration artifacts occur in some linear analysis systems because the nucleic acid may travel through the interrogation point at an increasing velocity. In other words, the front end (or head) of the nucleic acid travels through the interrogation point at a slower velocity than does the back end (or tail) of the nucleic acid. This may happen when the interrogation point exists in a long narrow microfluidic channel which is preceded by a region that is less narrow and usually of a different geometry. As an example, the long narrow channel may be preceded by a funnel shaped region of greater volume. The fluid velocity in the funnel region is generally lower than the velocity in the microchannel. If a nucleic acid is long enough to span both regions, then the head of the nucleic acid may be traveling through the interrogation point in the long narrow microfluidic channel, while the tail of the nucleic acid is traveling through the funnel shaped region. In this geometry, the tail is typically held up momentarily in the funnel region while the head is in the interrogation point. However, when the tail is in the interrogation point, there is nothing retarding its movement, and therefore the tail moves through the interrogation point faster than did the head. The traces of these nucleic acids may appear “overstretched” at the front end and may not match the corresponding theoretical signature traces well, thereby causing the problems for nucleic acid identification. This acceleration can be pictured as non-uniform stretching of the head of the nucleic acid, resulting in systematic mismatches between uniform theoretical signature traces and distorted experimental ones, and makes DNA identification (e.g., using the classification techniques described below) less reliable.

Some aspects and embodiments of the invention therefore relate to manipulating the traces from a nucleic acid to correct for the change in velocity of the nucleic acid as it passes through the interrogation point. Some embodiments provides methods for measuring the distortion, and then either correcting the experimental (i.e., observed) traces based on the measured distortion, or converting the theoretical trace into the observed trace by addition of the distortion.

In some embodiments, the acceleration correction (AC) technique takes a pair of head first (HF) and tail first (TF) observed signature traces belonging to the same DNA fragment, and tries to find the best match of HF with inverted TF by simultaneously distorting both traces.

The distortion can be represented by shifting counts in each interval by a Sin(πi/n) intervals, where i is the number of the current interval, n is the overall number of intervals, and a is the acceleration correction (AC) coefficient. The value of a characterizes the degree of the distortion for the nucleic acid of interest and for any nucleic acid of similar length. By extracting values of AC for several known nucleic acids and interpolating it for intermediate lengths, the dependence a(L) of the AC coefficient on the physical length of the DNA fragment L is obtained.

As stated above, this information may be used to add an acceleration effect to existing theoretical signature traces so that, when an observed trace is compared to a theoretical trace, the theoretical trace takes the acceleration of the nucleic acid through the microfluidic chamber into account.

Size Corrections: In another aspect, the invention provides methods for determining the length of nucleic acids. As described above, most nucleic acids being analyzed are fragments of longer naturally occurring nucleic acids such as chromosomes. These fragments may be generated by chemical, enzymatic, or mechanical methods. In one important embodiment, the fragments are generated by digestion with restriction endonucleases that faithfully recognize and cleave nucleic acid targets at specific sequences. Nucleic acids from microorganisms such as genetically modified organisms, or infectious agents, or some biowarfare agents (e.g., anthrax) will yield a characteristic set of nucleic acid fragments when cut with restriction enzymes. Mutations at the recognition and cleavage site in these microorganisms will result in a different set of fragments. These mutations may be detected at least by analysis of the number and lengths of fragments so generated. The fragment length can be determined based on the total signal derived from the backbone stains bound to the nucleic acids.

These and other methods of the invention may use one or more “calibrants” or standard nucleic acid fragments of known length (in kilobases and in microns) which may be labeled with a different (and thus distinguishable) stain. By incorporating these standards into a sample being analyzed, it is possible to correct for variations in experimental conditions that may cause run to run variation in fragment lengths. By adding a calibrant to a sample, the lengths of individual fragments of unknown size may be determined without significant impact of run-to-run variation.

This technique is based on a formula that converts kilobases to microns, and is expressed as Lₘ=α*L_{b}+βL_{b}², with L_{b} in kilobases, Lₘ the measured length in microns, α the stretching coefficient varying from run to run, and β a constant. According to this formula, for each run, while β is derived from known data sets and is fixed, α can be solved using the calibrant with known lengths in kilobases and in microns. That is, because both Lₘ and L_{b} are known for the calibrant, α can be determined using the formula α=(Lₘ−βL_{b}²)/L_{b}.

With α and β both known, we are then able to calculate the length in kilobases (L_{b}) for each non-calibrant fragment using its length in microns (Lₘ) observed in each run.

### DLA Blast Algorithm

The invention provides methods for comparing the sequence information from one sample to that obtained by another sample whether of known or unknown identity or source. The method is referred to herein as “DLA Blast” and it allows changes in nucleotide sequence (such as mutations) to be detected including small single point mutation and larger mutations such as 5-15 kilobase (kb) insertions or deletions.

In some embodiments, DLA BLAST allows for capturing genomic changes from as small as a single point mutation to as big as a 5-15 kb insertion or deletion. It may also, in some embodiments, enable identification of possible matches for any trace signals, even if the nucleic acid samples are sheared or partially digested.

For any unknown signal trace, DLA BLAST uses a sliding window approach to search for a possible match or a partial match within any specified genomes, using various stretching coefficients depending on either the Pearson correlation or the Spearman correlation. That is, it can be determined whether a trace for one nucleic acid fragment partially matches the trace for another nucleic acid fragment by conducting time-shifted correlation of the trace for one fragment with that of another fragment.

In some embodiments, to reduce the likelihood of false positives, two different correlation functions may be used to perform a time-shifted correlation of one fragment with another fragment. For example, in some embodiments the time-shifted correlation may be conducted using a Pearson correlation coefficient and a Spearmon correlation coefficient. The lower of these two correlation coefficients may be treated as the correlation coefficient of the two traces. Based on ROC curve analysis, Applicant has appreciated that using the minimal correlation between Pearson and Spearman correlations gives a 90% confidence that the possible match is a true match without few, if any, false positives.

Before one can conduct DLA BLAST for any trace signals, one needs to setup a DLA BLAST search database. Any suitable database may be used (e.g., a raw text database, a MySQL database, or any other suitable database). The searchable database may store the whole chromosome trace signals for the organisms you are interested in or previously collected experimental traces.

### Classification Algorithms Generally

The invention further provides methods for classifying fragments with respect to relatedness either to each other or to known sequences. The classification methods provided herein allow for the detection, in a sample, of known and unknown organisms based on nucleic acid content and sequence. It will be understood that these methods may be used to detect organisms, whether known or unknown, as well as other sources of nucleic acids (e.g., forensic samples). One endpoint of classification therefore involves grouping nucleic acids into classes most likely to have the same underlying sequence and optionally orientation (head-first or tail-first). Such classes may be nucleic acids that are similar to each other or nucleic acids that are similar to a known template. Head-first and tail-first orientations are typically independent sets, the similarity of which is indicative of reproducibility.

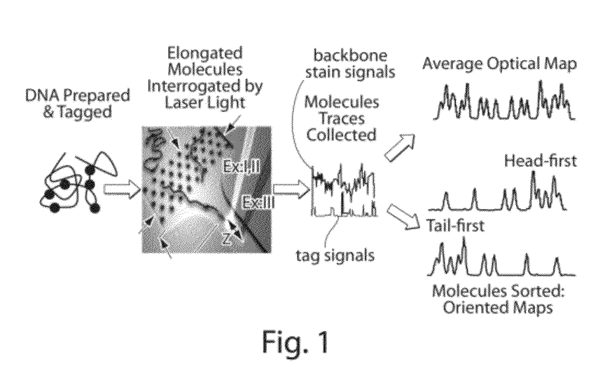

Classification schemes of the invention typically use probe binding profiles (or patterns or traces), whether oriented or unoriented. Orientation refers to whether the nucleic acid is analyzed in a head-first or a tail-first direction through the interrogation point. FIG. 1 illustrates the effect of combined head-first and tail-first traces on a data set. The intensity at each site in the oriented maps (bottom, right hand panel) is related to the occupancy of each site by a probe and the intensity of the signal at each site as a result of occupancy by the probe.

The various methods of the invention, including the classification methods of the invention, assume that the techniques used to generate a trace from nucleic acids in a sample are imperfect. For example, a probe may not bind to the nucleic acid target at its complementary site 100% of the time and/or it may bind to the nucleic acid target at a non-complementary site. An example of this latter instance is the binding of a probe to a site that has a single-end-mismatch (SEMM) from the probe. Some of the methods and algorithms provided herein take into account both of these situations. Such methods and algorithms may therefore assume that any peak in an optical trace (or map) may represent either a true match site or a SEMM site. In addition, light noise (i.e., outside light not generated by the fluorescence of a labeled probe when excited by a laser) may interfere with obtaining precise photon counts. Thus, the trace that is generated by a nucleic acid of particular type or class may differ from what the trace would have looked like under ideal conditions.

### Clustering Algorithms

The classification methods, in some instances, may be methods for clustering of traces using an “unsupervised learning technique.” These methods may be used to establish traces that are unique to (and potentially or representative or signature traces of) unknown organisms. Thus, the methods of the invention allow for the detection of unknown organisms or other sources of nucleic acids, and for the development of signature traces for such organisms or sources.

This technique may be used to group traces of nucleic acid fragments based only on similarity to each other without prior knowledge of sequences or theoretical signature traces to which an observed trace may be compared. Nucleic acid traces in the group may be treated as being related to the same nucleic acid fragment. The traces for each cluster may be averaged to generate a set of signature traces of nucleic acid fragments present in the sample.

This technique may be used to generate signature traces (also referred to herein as templates) for nucleic acid fragments without prior knowledge of their nucleotide sequence (e.g., not previously identified or not previously sequenced nucleic acid fragments). A library of these signature traces can be used to identify later analyzed nucleic acids (e.g., using the classification techniques described above). The technique can also be used to look for differences between various nucleic acid sources and to monitor genomic changes between these sources. For example, the technique can be used to detect differences between two or more samples of a particular microorganism, thereby identifying genetic differences between samples that may indicate a phenotypic or functional difference also (e.g., development of a drug resistance).

In some situations, it is important to extract information about signature traces of nucleic acids present in the sample without prior knowledge of the nucleic acid or its nucleotide sequence. This goal can be achieved by applying an unsupervised learning technique to the traces. In some embodiments, the unsupervised learning (clustering) technique may be applied to data sets according to the process described below.

The technique typically and generally involves the following:

(i) All traces present in the data set are compared to each other (i.e., each trace is compared to every other trace) and a distance that indicates similarity between two traces is assigned to each trace pair. The distance may be calculated in any suitable way. For example, the distance could be calculated in the manner described above, using the Spearman Rank Correlation metric (or any suitable variant thereof), or in any other suitable way.

(ii) The trace that has n neighbours with the lowest average distance to itself is declared a potential center of the cluster consisting of n traces. The trace that is declared the potential center and the traces of its n nearest neighbours are averaged together to generate a seed template. The same procedure is repeated until all the traces belong to the resulting clusters. It results in a set of seed templates representing the averages of trace clusters. The value of n may be any suitable value and may be defined in any suitable way. For example, in some embodiments, n may be 3, 4, 5, or any other suitable number.

(iii) Applicants have appreciated that some of the resulting averages, or “seed templates,” generated from steps (i) and (ii) may differ only by a small overall shift caused by velocimetry errors. Some of these averages may be similar, as they represent neighboring parts of very populated clusters. In some embodiments, such seed templates may be identified and merged into a single seed template.

(iv) Next, in some embodiments, each trace may be correlated with the seed template for each cluster, and may be assigned to the cluster of the seed template with the best correlation. All the traces of a particular cluster may be averaged together to generate a new seed template for the cluster, and steps (i)-(iv) may be repeated iteratively until no traces move between the clusters.

(v) In some embodiments, as the clusters are formed, brightness histograms for each bin of each cluster may be calculated. Re-clustering may be performed based on these histograms (natural distributions). The probability distance metric (described above in connection with nucleic acid classification) may be employed to calculate trace to cluster distances.

(vi) Applicants have appreciated that, in some situations, two different clusters may correspond to the same nucleic acid when one of these clusters corresponds to the nucleic acid in a head first orientation and the other corresponds to the nucleic acid in a tail first orientation. Thus, in some embodiments, pairs of matching head first (HF)—tail first (TF) clusters may be identified by comparing the average for each cluster with the inverted averages of each of the other clusters. In some situations, the similarity of the averages in potential HF-TF pairs may be maximized with respect to the acceleration correction coefficients. The resulting HF-TF pairs correspond to the DNA fragments present in the sample.

The above approach has been applied successfully to S. aureus strain differentiation.

### Classification Algorithms

Classification methods may involve comparison of observed traces to expected (or theoretical) traces from known organisms. Thus, rather than comparing pairs of observed traces and determining the degree of similarity between each member of the pair, some classification methods compare each observed trace to every template and determine the degree of similarity between the observed trace and every template. In this manner, it is possible to determine, for every observed trace, the template to which it is most closely related.

A nucleic acid may be classified by comparing its observed trace to stored traces for known nucleic acids, and determining which of these stored traces is the closest match and/or the degree to which each of these stored traces matches the observed trace. A stored trace may be a previously-observed trace or an average of previously-observed traces, or it may be a theoretical trace or an average of theoretical traces. Such comparison may be performed in a number of ways.

Classification in the case of known templates (e.g., previously sequenced nucleic acids or previously observed traces) may be accomplished in any suitable way. In some instances, it occurs iteratively, using either of two techniques. The first technique estimates bin intensity probability distributions, p(tᵢ, μᵢ), from unclassified distributions or approximate log-normal distributions, and then computes an approximate first classification from which improved bin intensity probability distributions can be computed. The second technique uses an initial approximate classification from assignments based on highest correlation between traces and templates. For both techniques, the nucleic acid classification and bin intensity distributions converge by iteration to a final accurate classification given sufficiently low noise.

Classification in the case of unknown nucleic acids (e.g., not previously sequenced nucleic acids) may be accomplished using many suitable techniques, of which two examples are described herein. In the first technique, randomly selected nucleic acids are used as initial templates and iterative classification is performed as for known templates except that with each iteration templates are updated with estimates from class averages. This is repeated with alternate sets of random nucleic acids until high confidence (e.g., maximum likelihood) classifications are obtained. In the second technique, sets of traces with high similarity (clusters) are used to generate initial estimates of templates and the algorithm continues as for known templates again allowing templates to be updated from class averages.

Thus, in some instances, the classification of DNA fragments in a particular sample may be based on maximum likelihood and machine learning techniques. These techniques may be used to handle the inherent noise and stochastic events at the single molecule level, and in some embodiments they may be used to handle the signal variability of confocal microscopy.

Fluorescence intensity is observed over the length of an individual nucleic acid from bound sequence-specific probes, and is used to create a trace. The trace corresponds to the number of photon counts existing in each of a number of equally spaced bins, i. A bin intensity probability distribution, p(tᵢ, μᵢ), expresses the probability of observing intensity t from a distribution in bin i with mean Initially, p(tᵢ, μᵢ) may not be known precisely but is either estimated from known approximate distributions, e.g. log-normal, or computed by smoothing intensity distributions observed in an approximate classification of a set of nucleic acids. In approximate forms, the bin intensity distributions are a function of only μᵢ, the mean intensity observed over a section of the nucleic acid in one class.

A “template” is the average trace expected for a class of identical nucleic acids and is given by a set of μᵢ. The probability of observing a particular trace from a class is P=πᵢp(tᵢ, μᵢ) under the approximation that bins are independent observations. That is, the probability that the nucleic acid corresponding to a particular observed trace comes from a particular class of nucleic acids can be expressed as the product of the probability of observing the observed intensity in each bin. The fraction of nucleic acids in a class in any bin along the length of the nucleic acid can be computed as the proportion of nucleic acids with intensity exceeding background fluorescence levels.

A nucleic acid may be identified as belonging to a particular class if it is more likely to be observed from that class than all others, i.e. P₁>P₂.

In some embodiments, because the probabilities, P, are numerically small, they may be expressed for convenience as negative logs and referred to informally as “distances”, where the distance, D, for a given probability, P, can be expressed as D≡−log(P). Relative likelihood, e.g. P₁/P₂, may be expressed as a difference in distance, ΔD=D₁−D₂. Thus, the smaller the value for ΔD for a particular observed trace and a particular template for a class, the more likely it is that the nucleic acid corresponding to the observed trace belongs to the class.

Below is an exemplary process for classifying nucleic acid fragments based on similarity to other known fragments. This nucleic acid classification technique is designed for the single molecule analysis of a set of experimentally registered optical traces from individual nucleic acids with the goal of classifying them into categories of events similar to templates associated with known nucleic acid fragments. These templates are either theoretically predicted for the sequenced organisms or empirically obtained by a linear analysis experiment with subsequent clustering analysis, as described herein. This technique provides the ability to detect with high sensitivity the relevant nucleic acid fragments in the presence of background organisms. This technique logically follows the step of finding nucleic acids in raw linear analysis data and may incorporate some of the other algorithms described herein.

An exemplary classification process may involve the following:

1. Initial handling of nucleic acids: Nucleic acids are analyzed for the quality of their backbone signal (e.g., resulting from intercalation). Nucleic acids with areas of non-uniformly elevated backbone signal (e.g., indicating non-uniform stretching) are filtered out. This step is called backbone filtering. The brightness of the probes is analyzed and nucleic acids with unusually bright spikes of probe signal may be filtered out as well (e.g., potential non-specific tagging or other optical noise).

2. Evaluation of parameters related to the length of nucleic acid fragments: The stretching of nucleic acids is evaluated in order to find length correspondence between measured nucleic acids (in microns) and theoretical predictions (in basepairs). The stretching coefficient may be obtained from the specially designed length calibration algorithm, described above. The parameters of the length distribution of molecules of the single nucleic acid fragment are defined. This profile shape of the length distribution defines the length term for the comparison metric.

3. Preparation of templates: The information about theoretically and/or empirically expected optical traces (i.e., templates) is loaded from the database. Templates are mathematically transformed to model the linear non-uniformity caused by the accelerated movement of nucleic acids. This step is called “acceleration modeling”, as opposed to “acceleration correction” which is a transformation inverse to modeling and is applied to nucleic acid traces in order to symmetrize the traces for “head first” and “tail first” orientations. Probabilistic models of the expected photon distributions for every interval along the nucleic acid's length are generated.

4. Classification: In the classification steps, every nucleic acid from the data set is compared to every template. The comparison involves the estimation of the probability that a nucleic acid fragment corresponding to the length and optical signal of the given template will produce exactly the same signal as the considered nucleic acid. The negative logarithm of this probability (i.e., the distance from the nucleic acid to the template) is stored. Thus, for every nucleic acid an array of distances is obtained to all templates used in the classification. The nucleic acid is classified as a fragment of its nearest template.

There are several classification algorithms (or metrics) that may be used for molecule classification. Examples include (1) Log-normal (described above), which is based on theoretical statistical predictions of photon distribution; (2) Correlation, which is based on correlation of molecule signal to the theoretical template; and (3) Natural Distribution, which is an iterative method using the mix of one of the two first methods in combination with the statistical distribution of experimental data. It should be appreciated that these are only examples of metrics that can be used, and the invention is not limited to these particular metrics, as any suitable metric may be used. In some embodiments, a user may select which metrics are to be applied for the classification of a nucleic acid. The user may select a single one of these metrics or may select multiple of these metrics to be used in combination.

In some embodiments, each metric has a threshold value associated with it. By setting the threshold value, the user specifies that the nucleic acids are allowed to be attributed to a specific class only when a specified degree of certainty is obtained. Note that, in some embodiments, when the threshold is applied, a certain number of nucleic acids may be considered as too ambiguous for classification and will be marked as “unclassified.”

In the case of the correlation metric, the threshold defines a value of the correlation between the signal of the individual nucleic acid and the theoretical template. The correlation may have a value from −1 to +1. Hence if the threshold value is set to −1, then no threshold is activated. The recommended values lie in the range from −0.2 to +0.25.

In the case of log-normal and natural distribution metrics, the threshold value is defined as the minimum percentage value of the mean statistical “distance” of the unclassified data set. The value of 0% means that the threshold is not activated. The recommended values lie in the range from 1% to 5%.

The natural distribution is the iterative classification method that relies on the preliminary sorting performed by the log-Normal or correlation method. Note that, in some embodiments, the threshold value for the preliminary classification may differ from the threshold value for the same algorithm used by itself, though it is not required to. For example, one can decide to run for comparison the Log-normal and Natural Distribution metrics with similar threshold values of 2%, but for preliminary sorting use Log-normal method with no threshold activated. In that case there will be two runs of Log-normal metrics: one with the 0% threshold for presorting (and it will be marked as Presort_LogNormal in the results window) and one with the 2% threshold value.

Some examples of choices of metrics that may be used in nucleic acid classification are shown in Table 1. The Natural Distribution classification performs two iterative runs after the presorting is done. All together there are 1 to 5 possible classification runs within one classification process. It should be appreciated that the illustrative threshold values in the table below are merely examples of threshold values that may be selected, and the invention is not limited to these particular threshold values, as any suitable values may be used.

TABLE 1
Examples of possible combinations of classification metrics

| | | Number of |
|---|---|---|
| | | Classification |
| Choice of Metrics in Dialog | Metrics to be Run | Runs |
| Log-normal only | Log-normal | 1 |
| Correlation only | Correlation | 1 |
| Log-normal and Correlation | Log-normal | 2 |
| | Correlation | |
| Natural Distribution only | Log-normal | 3 |
| with Log-normal initial | Natural Distribution, run 1 | |
| sorting | Natural Distribution, run 2 | |
| Log-normal, threshold 1% | Log-normal, threshold 1% | 3 |
| Natural Distribution with | Natural Distribution, run 1 | |
| Log-normal initial sorting | Natural Distribution, run 2 | |
| (same threshold, 1%) | | |
| Log-normal, threshold 2% | Log-normal, threshold 2% | 4 |
| Natural Distribution with | Presort_Log-normal, | |
| Log-normal initial sorting | threshold 0% | |
| (with a differing threshold | Natural Distribution, run 1 | |
| 0%) | Natural Distribution, run 2 | |
| Log-normal | Log-normal | 5 |
| Correlation, threshold 0.15 | Correlation, threshold 0.15 | |
| Natural Distribution with | Presort_Correlation, | |
| Correlation initial sorting | threshold 0.0 | |
| (threshold 0.0) | Natural Distribution, run 1 | |
| | Natural Distribution, run 2 | |

As a result, for every nucleic acid an array of distances to all templates participating in the classification is obtained. The nucleic acid may be classified as a fragment of a particular template based on the distance between the fragment and the template.

In some embodiments, molecules may be filtered out (i.e., not classified) based on length. That is, the user may specify a minimum length threshold and/or a maximum length threshold, and fragments whose physical length does not fall within the specified length range may not be classified.

In some embodiments, each molecule to be classified may get padding of the edges to make it more compatible with the theoretically generated templates. The default value is 2.55 microns. This parameter may be adjusted depending on characteristics of the theoretical templates and/or software that generates the theoretical templates.

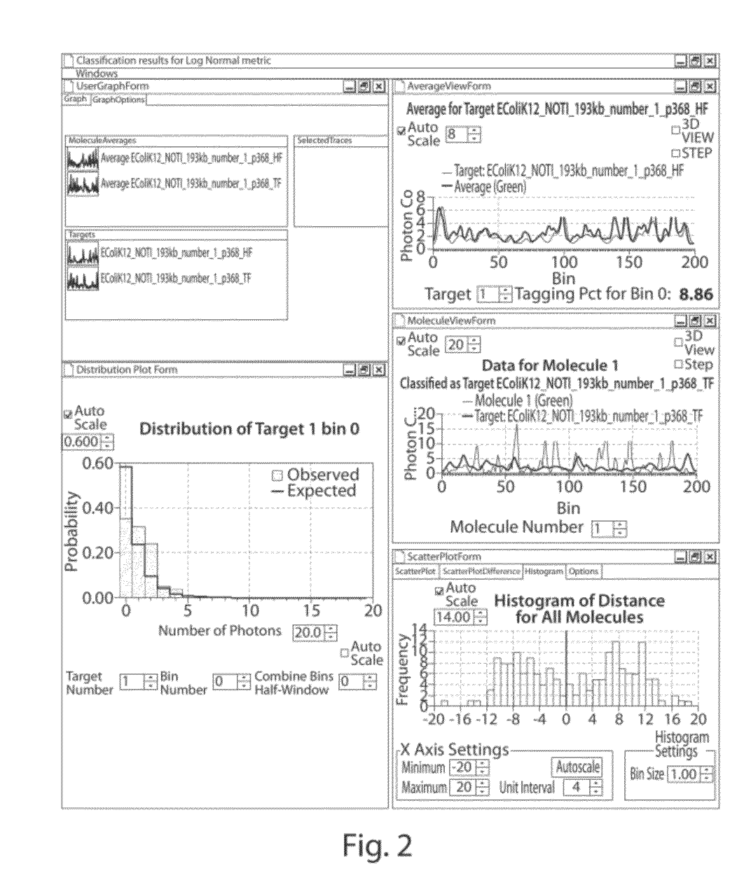

5. Presentation of the results and evaluation of the sorting: In some embodiments, several aspects of the classification results may be displayed visually to provide visual evaluation of results. For example, plots that include comparison of the average traces of the classified group to predicted template may be generated and displayed; plots that include a comparison of an individual molecule to a theoretical template may be displayed; scatter plots of nucleic acids may be generated and displayed; and distribution histogram demonstrating separation of the “head first” and “tail first” nucleic acids may be generated and displayed; fragment histograms evaluating log-likelihood of classification may be generated and displayed. Examples of some of these plots are shown in FIG. 2.

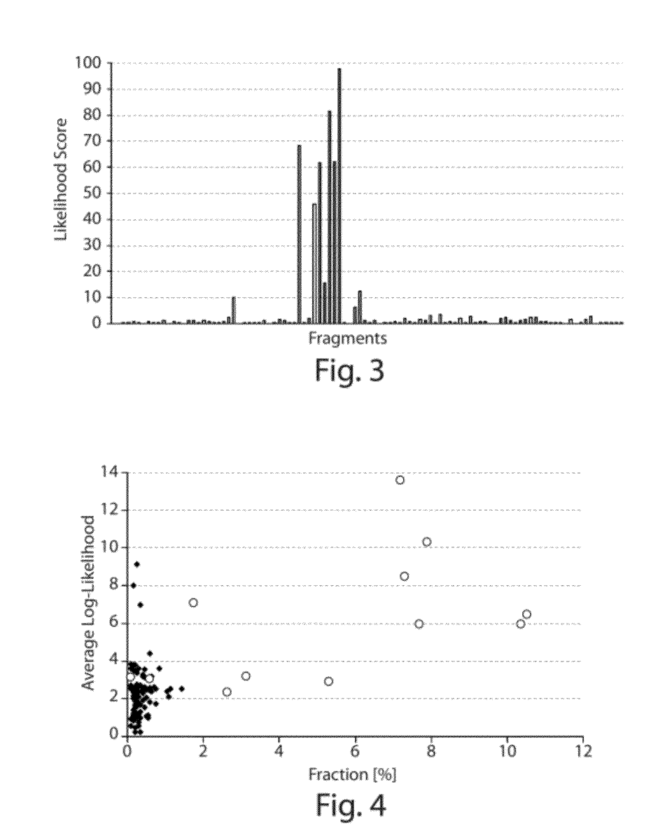

In some embodiments, when the data set is evaluated by comparison to nucleic acids from a wide range of microorganisms, techniques for reducing potential false positive detection results can be employed. Such techniques may include: (1) Evaluation of the average log-likelihood for nucleic acids to create each cluster; (2) Elimination of the clusters with either low log-likelihood or very low numbers of nucleic acids (see FIGS. 3 and 4, which show an example of results of a comparison of a detected E. coli K12 data set to multiple signal templates). As shown in FIGS. 3 and 4, only the nucleic acids identified as fragments of E. coli K12 exhibit the likelihood score above the illustrative threshold of about 5.0, indicating success of detection); (3) The “gap critic” technique which evaluates the correlation between average traces and expected templates and eliminates clusters with the low gap between correlation to the target to which it is assigned and correlation to all other targets; and/or (4) Hierarchical mini-clustering of single nucleic acids into small groups of several nucleic acids with subsequent merging of their optical traces and classification of these averaged groups has been tested and implemented. In some experimental situations, this approach provides good practical results.

### Pathogen Identification Algorithms

The invention provides methods for identification of organisms including microorganisms, whether known or unknown, based on linear analysis signature traces and genomic metrics. These methods are used to analyze a plurality of nucleic acids in a sample and to determine the likelihood or probability that the sample contains a particular organism by virtue of its nucleic acid content. The method therefore yields a relative probability that the sample is more likely to contain one organism instead of another. This probability is determined based on an analysis of as many nucleic acids in the sample as possible, as the greater the data set used to make the determination, the greater the confidence applied to the ultimate probability.

In some embodiments, a technique which calculates an estimate of the most likely single biological source of measured linear analysis data may be used. In some embodiments, this technique may use the “data-to-genome” metric that calculates the distances from a measured trace to various sets of predicted optical traces in assumption that all the measured data comes from a single biological source (monoculture), albeit with potential presence of the unknown background. As a result, this technique reflects which of the known strains from the database is the most probable source of the data, and helps to identify a sample.

Applicants have appreciated that for measured unsequenced strains, it is possible to calculate which of the sequenced strains is the closest to the data and hence estimate the similarity of the analyzed organism to known organisms. In addition, Applicants have appreciated that, in many cases, an unknown microorganism may be identified by finding similarity between its observed traces and predicted or theoretical traces for a specific sequenced microorganism.

Some aspects of this technique are described above in connection with the discussion of nucleic acid classification. These aspects include: initial handling of nucleic acids (i.e., backbone and brightness filtering; stretching evaluation in order to find length correspondence between measured nucleic acids (in microns) and theoretical predictions (in basepairs); modeling of the length distribution of nucleic acids; acceleration correction; creation of a database of theoretically and/or empirically expected optical traces (i.e., templates); and choice of a metric for comparison of individual optical traces to predictions (i.e., LogNormal probabilistic metric).

In addition, this technique defines the background model and concentration of unknown background nucleic acids in the data sample. This may be accomplished using a “data-to-genome”metric, in which the probability that all measured nucleic acids in the whole data set would produce the observed set of optical signals, on the condition that the data originated from a single genome.

This metric can be expressed as

$$p ( data \vert {genome}_{i} ) = {\prod }_{j} \frac{1}{N} {\sum }_{k = 1}^{{N}_{i}} p ( {l}_{j} \vert {T}_{i , k} ) \cdot p ( {S}_{j} \vert {T}_{i , k} ) \cdot P ( {l}_{j} ) ,$$

where: i is the considered genome, j is an observed DNA molecule, k is a digest fragment of the genome i, Nᵢ is the number of fragments, lⱼ is the length of a molecule, Sⱼ is the optical signal of a molecule, T_{i,k} is the template of a fragment k of genome i, p(lⱼ|T_{i,k}) is the probability to observe a molecule of a given length for a specific template, p(Sⱼ|T_{i,k}) is the probability to observe a specific optical trace for a specific template, P(l) length throughput function of the system.

Because the probability resulting from this metric may be small, it may be expressed as distance by taking the negative log, as shown in the equation below.

D=−log [p(data|genomeᵢ)]

Then the difference of distances is the relative log-likelihood Dᵢⱼ which is proportional to the logarithm of the ratio of probabilities that data originate from genomes i and j, as shown in the equation below.

$${D}_{ij} = {D}_{j} - {D}_{i} ∝ log \frac{p ( data \vert {genome}_{i} )}{p ( data \vert {genome}_{j} )}$$

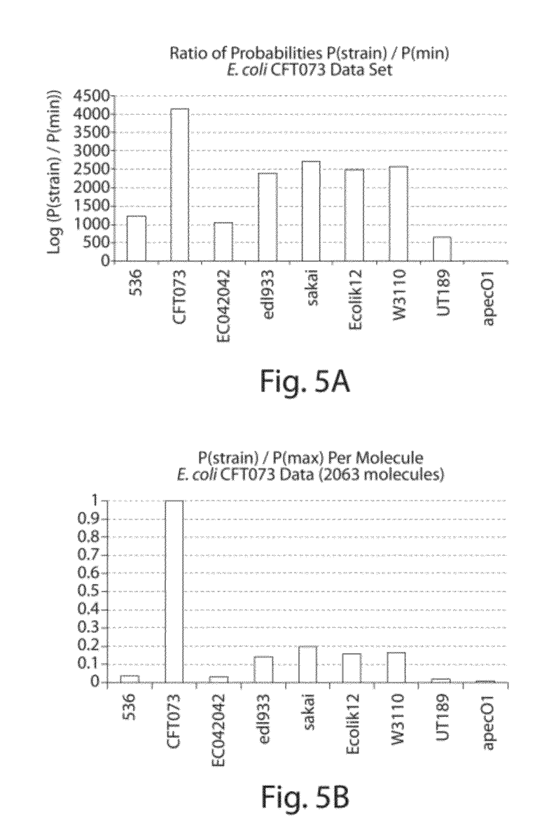

As a result, this method produces one number (“distance”) for each strain that is proportional to the logarithm of probability that the measured data have originated from a particular genome. Difference of the two distances for two different genomes is proportional to the ratio of corresponding probabilities, as shown in FIG. 5A.

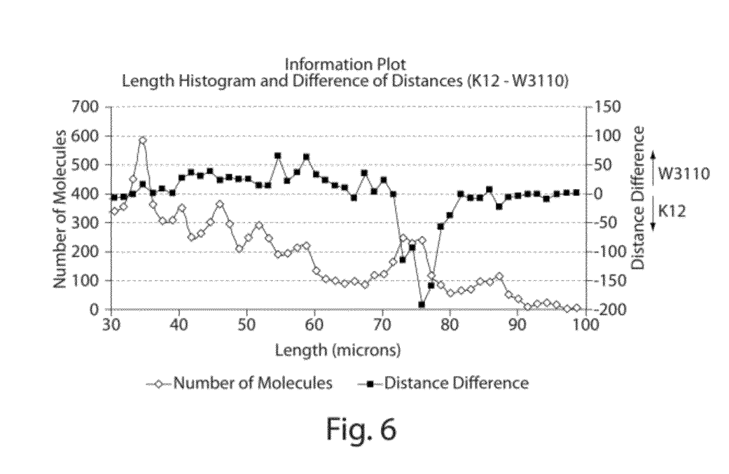

Applicants have appreciated that there are several methods of presenting data: (1) The ratio of probabilities for the whole strain (shown in FIG. 5A); (2) The ratio of probabilities shown in average per molecule, which often highlights similarities between various strains (shown above in FIG. 5B); (3) So called “length information” or “specific distance” plot (shown in FIG. 6) which indicates which DNA fragments in the data set point to which strain as a most probable source.

### Phylogenic Analyses

The invention provides methods relating to bacterial phylogeny and associations of antibiotic resistance using linear analysis signature traces. In this aspect, the methods of the invention yield data sets that can be used to classify nucleic acids in terms of evolutionary relatedness. The methods can also be used to identify, prior to clinical verification, antibiotic resistance in a sample based on the sequence information obtained using the various methods described herein. This latter aspect allows clinicians to identify resistant strains without unnecessarily prescribing ineffective antibiotics to a patient.

The technique provides for inferring phylogenetic relationships between various bacterial strains based on their signature traces. Clusters with resistance or sensitivity to certain antibiotics can be identified in a phylogenetic tree, and the antibiotic resistance for unknown clinical samples may be predicted.

A set of average optical traces for each nucleic acid fragment measured using nucleic acid clustering techniques described above may be obtained. One sample may be compared to another using the following steps:

(1) Compare every fragment in one sample to every fragment in another using the Partial Fragment Comparison technique referred to above as DLA BLAST. Pick the positive matches based on a threshold.

(2) Calculate a Sample Similarity Index for the two samples. Sample Similarity Index is a measure of the ratio of total length of traces that were considered to be positive matches to the total length of the traces measured.

The Sample Similarity Index (SSI) can be calculated for each pair of samples measured. SSI is a measure of distance between the two samples. We can generate a distance matrix for the samples measured and use this matrix to generate a phylogenetic tree using standard algorithms available. We can create the tree for samples for which Antibiotic Sensitivity data is available. By looking at the position of the unknown sample in the tree of knowns we will be able to infer the Antibiotic Sensitivity profile for the unknown sample.

It is to be understood that the various manipulations and algorithms provided herein may be performed manually although computer-means may be preferred. In either instance, the input data is transformed from raw data to observed traces, and optionally to averaged traces, which optionally are compared to theoretical traces. These various outputs may be presented in a number of ways, including without limitation those shown in FIGS. 2-13D.

### Data Acquisition Systems

The data manipulated by the methods of the invention may be obtained using a single molecule analysis system. Such a system is capable of analyzing single molecules either in a linear manner (i.e., starting at a point and then moving progressively in one direction or another) and, as may be more appropriate in the present invention, in their totality.

A single molecule detection system is capable of analyze single molecules separate from other molecules. An example of such a single molecule detection system is the GeneEngine™ (U.S. Genomics, Inc., Woburn, Mass.). The Gene Engine™ system is described in PCT patent applications WO98/35012 and WO00/09757, published on Aug. 13, 1998, and Feb. 24, 2000, respectively, and in issued U.S. Pat. No. 6,355,420 B1, issued Mar. 12, 2002. The GeneEngine™ platform can be adapted into a rapid automated biological identification system instrument. This can be accomplished by adding select functions to the platform, such as advanced microfluidics for agent concentration, and removing select components, such as the potentially unnecessary and expensive confocal optics.

Labeled polymers, such as labeled nucleic acids as described below in greater detail, are exposed to an energy source in order to generate a signal from the label. As used herein, the labeled polymer is “exposed” to an energy source by positioning or presenting the labeled probe bound to the polymer in interactive proximity to the energy source such that energy transfer can occur from the energy source to the labeled probe, thereby producing a detectable signal. Interactive proximity means close enough to permit the interaction or change which yields that detectable signal.

The energy source may be selected from the group consisting of electromagnetic radiation, and a fluorescence excitation source, but is not so limited. “Electromagnetic radiation” as used herein is energy produced by electromagnetic waves. Electromagnetic radiation may be in the form of a direct light source or it may be emitted by a light emissive compound such as a donor fluorophore. “Light” as used herein includes electromagnetic energy of any wavelength including visible, infrared and ultraviolet. A fluorescence excitation source as used herein is any entity capable of making a source fluoresce or give rise to photonic emissions (i.e., electromagnetic radiation, directed electric field, temperature, physical contact, or mechanical disruption.)

The labeled polymer may be exposed to a station to produce distinct signals arising from the labels of the probes. As used herein, a labeled polymer is “exposed” to a station by positioning or presenting the labeled probe bound to the polymer in interactive proximity to the station such that energy transfer or a physical change in the station can occur, thereby producing a detectable signal. A “station” as used herein is a region where a portion of the polymer (having a labeled probe bound thereto) is exposed to an energy source in order to produce a signal or polymer dependent impulse. The station may be composed of any material including a gas, but preferably the station is a non-liquid material. In one preferred embodiment, the station is a composed of a solid material. If the labeled probe interacts with the energy source at the station, then it is referred to as an interaction station. An “interaction station” is a region where a labeled probe and the energy source can be positioned in close enough proximity to each other to facilitate their interaction. The interaction station for fluorophores is that region where the labeled probe and the energy source are close enough to each other that they can energetically interact to produce a signal.

When the labeled probes are sequentially exposed to the station and/or the energy source, the probe (and thus polymer) and the station and/or the energy source move relative to each other. As used herein, when the probe and the station and/or energy source move relative to each other, this means that either the probe (and thus polymer) or the station and/or the energy source are both moving, or alternatively only one of the two is moving and other is stationary. Movement between the two can be accomplished by any means known in the art. As an example, the probe and polymer can be drawn past a stationary station by an electric current. Other methods for moving the probe and polymer past the station include but are not limited to magnetic fields, mechanical forces, flowing liquid medium, pressure systems, suction systems, gravitational forces, and molecular motors (e.g., DNA polymerases or helicases if the polymer is a nucleic acid, and myosin when the polymer is a peptide such as actin). Polymer movement can be facilitated by use of channels, grooves, or rings to guide the polymer. The station is constructed to sequentially receive the target polymer (with labeled probes bound thereto) and to allow the interaction of the label and the energy source.

The interaction station in a preferred embodiment is a region of a nanochannel where a localized energy source can interact with a polymer passing through the channel. The point where the polymer passes the localized region of agent is the interaction station. As each labeled probe passes by the energy source a detectable signal is generated. The energy source may be a light source which is positioned a distance from the channel but which is capable of transporting light to directly to a region of the channel through a waveguide. An apparatus may also be used in which multiple polymers are transported through multiple channels. The movement of the polymer may be assisted by the use of a groove or ring to guide the polymer.

### Nucleic Acid Preparation

Samples to be tested for the presence of organisms are generally taken from an indoor or outdoor environment. These include samples taken from air, liquids or solids in an indoor or outdoor environment. Air samples can be taken from a variety of places suspected of being biowarfare targets including public places such as airports, hotels, office buildings, government facilities, and public transportation vehicles such as buses, trains, airplanes, and the like. Liquid samples can be taken from public water supplies, water reservoirs, lakes, rivers, wells, springs, and commercially available beverages. If necessary, concentration of liquid samples can be done by centrifugation, evaporation, lyophilization, and the like. Other liquid samples include bodily fluid samples such as blood, plasma, sputum, lymph, urine, and the like. Solids such as bodily tissues including stool samples and sputum can be tested. Other solids include food (including baby food and formula), money (including paper and coin currencies), public transportation tokens, books, and the like can also be sampled via swipe, wipe or swab testing and placing the swipe, wipe or swab in a liquid for dissolution of any agents attached thereto. Again, based on the size of the swipe or swab and the volume of the corresponding liquid it must be placed in for agent dissolution, it may be necessary to concentrate such liquid sample prior to further manipulation. Air, liquids and solids that will come into contact with the greatest number of people are most likely to be targets of biohazardous agent release.

Sampling can occur continuously, although this may not be necessary in every application. For example, in an airport setting, it may only be necessary to harvest randomly a sample near or around select baggage. In other instances, it may be necessary to continually monitor (and thus sample the environment). These instances may occur in “heightened alert” states.

A “polymer” as used herein is a compound having a linear backbone to which monomers are linked together by linkages. The polymer is made up of a plurality of individual monomers. An individual monomer as used herein is the smallest building block that can be linked directly or indirectly to other building blocks or monomers to form a polymer. At a minimum, the polymer contains at least two linked monomers. The particular type of monomer will depend upon the type of polymer being analyzed. In preferred embodiments, the polymer is a nucleic acid molecule such as a DNA or RNA molecule. The invention is however not so limited and could be used to label and analyze non-nucleic acid polymers. With the advent of aptamer technology, it is possible to use nucleic acid based probes in order to recognize and bind a variety of compounds, including peptides and carbohydrates, in a structurally, and thus sequence, specific manner

“Sequence-specific” when used in the context of a nucleic acid molecule means that the probe recognizes a particular linear arrangement of nucleotides or derivatives thereof. When used in the context of a peptide, sequence-specific means the probe recognizes a particular linear arrangement of nucleotides or nucleosides or derivatives thereof, or amino acids or derivatives thereof including post-translational modifications such as glycosylations. When used in the context of a carbohydrate, sequence specific means the probe recognizes a particular linear arrangement of sugars.

The polymers to be analyzed are referred to herein as “target” molecules or polymers. In some important embodiments, the target molecules are DNA, or RNA, or amplification products or intermediates thereof, including complementary DNA (cDNA). DNA includes genomic DNA (such as nuclear DNA and mitochondrial DNA), as well as in some instances cDNA. In important embodiments, the nucleic acid molecule is a genomic nucleic acid molecule. The nucleic acid molecules may be single stranded and double stranded nucleic acids.

The nucleic acid molecules can be directly harvested and isolated from a biological sample (such as a bodily tissue or fluid sample, or a cell culture sample) without the need for prior amplification using techniques such as polymerase chain reaction (PCR). Harvest and isolation of nucleic acid molecules are routinely performed in the art and suitable methods can be found in standard molecular biology textbooks (e.g., such as Maniatis' Handbook of Molecular Biology).

The methods provided herein are capable of generating signatures for each polymer based on the specific interactions between probes and target polymers. A signature is the signal pattern that arises along the length of a polymer as a result of the binding of probes to the polymer. The signature of the polymer uniquely identifies the polymer or the source of the polymer. The identity of the target polymer to which a probe binds need not be known prior to analysis, although for some applications, it will be known. This may be the case, for example, where a particular condition such as an infection with an antibiotic resistance microorganism is diagnosed based on the presence or absence of a particular target nucleic acid, including a genomic DNA fragment or an RNA transcript.

The methods of the invention generally require exposing a target molecule to a probe. As used herein, this means that the target molecule is physically combined with the probe, and the target and probe are allowed to hybridize with each other provided they have complementary sequences, in the case of nucleic acids.

The term “nucleic acid” is used herein to mean multiple nucleotides (i.e., molecules comprising a sugar (e.g., ribose or deoxyribose) linked to an exchangeable organic base, which is either a substituted pyrimidine (e.g., cytosine (C), thymidine (T) or uracil (U)) or a substituted purine (e.g., adenine (A) or guanine (G)). As used herein, the terms refer to oligoribonucleotides as well as oligodeoxyribonucleotides. The terms shall also include polynucleosides (i.e., a polynucleotide minus a phosphate) and any other organic base containing polymer. Nucleic acid molecules can be obtained from existing nucleic acid sources (e.g., genomic or cDNA), or by synthetic means (e.g., produced by nucleic acid synthesis). The target nucleic acid molecules commonly have a phosphodiester backbone because this backbone is most common in vivo.

The methods provided herein involve the use of a probe that binds to the polymer being studied in a sequence-specific manner A probe is a molecule that specifically recognizes and binds to particular sequences within a polymer in a sequence-specific manner.

Binding of a probe to a nucleic acid indicates the presence and location of a sequence in the target nucleic acid that is complementary to the sequence of the probe, as will be appreciated by those of ordinary skill in the art. As used herein, a polymer that is bound by a probe is “labeled” with the probe. The position of the probe along the length of a target polymer indicates the location of the complementary sequence in the polymer.

The probe may itself be a polymer but it is not so limited. Examples of suitable probes are nucleic acids and peptides and polypeptides. As used herein a “peptide” is a polymer of amino acid residues connected preferably but not solely with peptide bonds. Other probes include but are not limited to sequence-specific major and minor groove binders and intercalators, nucleic acid binding peptides or polypeptides, sequence-specific peptide-nucleic acids (PNAs), and peptide binding proteins, etc.

The probes can include nucleotide derivatives such as substituted purines and pyrimidines (e.g., C-5 propyne modified bases (Wagner et al., 1996, Nature Biotechnology, 14:840-844)). Suitable purines and pyrimidines include but are not limited to adenine, cytosine, guanine, thymidine, 5-methylcytosine, 2-aminopurine, 2-amino-6-chloropurine, 2,6-diaminopurine, hypoxanthine, and other naturally and non-naturally occurring nucleobases, substituted and unsubstituted aromatic moieties. The probes can also include non-naturally occurring nucleotides, or nucleotide analogs. Other such modifications are known to those of skill in the art.

The probes also encompass substitutions or modifications, such as in the bases and/or sugars. For example, they include nucleic acid molecules having backbone sugars which are covalently attached to low molecular weight organic groups other than a hydroxyl group at the 3′ position and other than a phosphate group at the 5′ position. Thus, modified nucleic acid molecules may include a 2′-O-alkylated ribose group. In addition, modified nucleic acid molecules may include sugars such as arabinose instead of ribose. Thus the probes may be heterogeneous in composition at both the base and backbone level. In some embodiments, the probes are homogeneous in backbone composition (e.g., all phosphodiester, all phosphorothioate, all peptide bonds, etc.).

The probe can be of any length, as can the sequence to which it binds. In instances in which the polymer and the probe are both nucleic acid molecules, the length of the probe and the sequence to which it binds are generally the same. The length of the probe will depend upon the particular embodiment. The probe may range from at least 4, at least 5, at least 6, at least 7, at least 8, at least 9, at least 10, at least 12, at least 15, at least 20, at least 25, at least 50, at least 75, at least 100, at least 150, at least 200, at least 250, at least 500, or more nucleotides (including every integer therebetween as if explicitly recited herein). Preferably, the probes are at least 8 nucleotides in length to in excess of 1000 nucleotides in length.

In some embodiments, shorter probes are more desirable, since they provide much sequence information leading to a higher resolution sequence map of the target nucleic acid molecule. Longer probes are desirable when unique gene-specific sequences are being detected. The length of the probe however determines the specificity of binding. Proper hybridization of small sequences is more specific than is hybridization of longer sequences because the longer sequences can embrace mismatches and still continue to bind to the target depending on the conditions. One potential limitation to the use of shorter probes however is their inherently lower stability at a given temperature and salt concentration. In order to avoid this latter limitation, bisPNA or two-arm PNA probes can be used which allow both shortening of the probe and sufficient hybrid stability in order to detect probe binding to the target nucleic acid molecule.

The probes of the invention are labeled with detectable molecules. As used herein, the terms “detectable molecules” and detectable labels” are used interchangeably. The detectable molecule can be detected directly, for example, by its ability to emit and/or absorb light of a particular wavelength. Alternatively, a molecule can be detected indirectly, for example, by its ability to bind, recruit and, in some cases, cleave another molecule which itself may emit or absorb light of a particular wavelength, for example. An example of indirect detection is the use of an enzyme which cleaves an exogenously added substrate into visible products. The label may be of a chemical, peptide or nucleic acid nature although it is not so limited. When two or more detectable molecules are to be detected, the detectable molecules should be distinguishable from each other. This means that each emits a different and distinguishable signal from the other.

Detectable molecules can be conjugated to probes using chemistry that is known in the art. The labels may be directly linked to the DNA bases or may be secondary or tertiary units linked to modified DNA bases. Labeling with detectable molecules can be carried out either prior to or after binding to a target nucleic acid molecule. In preferred embodiments, a single nucleic acid molecule is bound by several different probes at a given time and thus it is advisable to label such probes prior to target binding. Labeled probes are also commercially available.

Generally, the detectable molecule can be selected from the group consisting of an electron spin resonance molecule (such as for example nitroxyl radicals), a fluorescent molecule, a chemiluminescent molecule, a radioisotope, an enzyme substrate, a biotin molecule, an avidin molecule, a streptavidin molecule, an electrical charged transducing or transferring molecule, a nuclear magnetic resonance molecule, a semiconductor nanocrystal or nanoparticle, a colloid gold nanocrystal, an electromagnetic molecule, a ligand, a microbead, a magnetic bead, a paramagnetic particle, a quantum dot, a chromogenic substrate, an affinity molecule, a protein, a peptide, a nucleic acid molecule, a carbohydrate, an antigen, a hapten, an antibody, an antibody fragment, and a lipid.

Specific examples of detectable molecules include radioactive isotopes such as P³² or H³, fluorophores such as fluorescein isothiocyanate (FITC), TRITC, rhodamine, tetramethylrhodamine, R-phycoerythrin, Cy-3, Cy-5, Cy-7, Texas Red, Phar-Red, allophycocyanin (APC), epitope tags such as the FLAG or HA epitope, and enzyme tags such as alkaline phosphatase, horseradish peroxidase, β-galactosidase, and hapten conjugates such as digoxigenin or dinitrophenyl, etc. Other detectable markers include chemiluminescent and chromogenic molecules, optical or electron density markers, etc. The probes can also be labeled with semiconductor nanocrystals such as quantum dots (i.e., Qdots), described in U.S. Pat. No. 6,207,392. Qdots are commercially available from Quantum Dot Corporation.

In some embodiments, the probes are labeled with detectable molecules that emit distinguishable signals detectable by one type of detection system. For example, the detectable molecules can all be fluorescent labels or radioactive labels. In other embodiments, the probes are labeled with molecules that are detected using different detection systems. For example, one probe may be labeled with a fluorophore while another may be labeled with radioactive molecule.

Analysis of the nucleic acid involves detecting signals from the detectable molecules, and determining their position relative to one another. In some instances, it may be desirable to further label the target nucleic acid molecule with a standard marker that facilitates comparison of information obtained from different targets. For example, the standard marker may be a backbone label, or a label that binds to a particular sequence of nucleotides (be it a unique sequence or not), or a label that binds to a particular location in the nucleic acid molecule (e.g., an origin of replication, a transcriptional promoter, a centromere, etc.).

One subset of backbone labels are nucleic acid stains that bind nucleic acid molecules in a sequence independent or sequence non-specific manner Examples include intercalating dyes such as phenanthridines and acridines (e.g., ethidium bromide, propidium iodide, hexidium iodide, dihydroethidium, ethidium homodimer-1 and -2, ethidium monoazide, and ACMA); some minor grove binders such as indoles and imidazoles (e.g., Hoechst 33258, Hoechst 33342, Hoechst 34580 and DAPI); and miscellaneous nucleic acid stains such as acridine orange (also capable of intercalating), 7-AAD, actinomycin D, LDS751, and hydroxystilbamidine. All of the aforementioned nucleic acid stains are commercially available from suppliers such as Molecular Probes, Inc. Still other examples of nucleic acid stains include the following dyes from Molecular Probes: cyanine dyes such as SYTOX Blue, SYTOX Green, SYTOX Orange, POPO-1, POPO-3, YOYO-1, YOYO-3, TOTO-1, TOTO-3, JOJO-1, LOLO-1, BOBO-1, BOBO-3, PO-PRO-1, PO-PRO-3, BO-PRO-1, BO-PRO-3, TO-PRO-1, TO-PRO-3, TO-PRO-5, JO-PRO-1, LO-PRO-1, YO-PRO-1, YO-PRO-3, PicoGreen, OliGreen, RiboGreen, SYBR Gold, SYBR Green I, SYBR Green II, SYBR DX, SYTO-40, -41, -42, -43, -44, -45 (blue), SYTO-13, -16, -24, -21, -23, -12, -11, -20, -22, -15, -14, -25 (green), SYTO-81, -80, -82, -83, -84, -85 (orange), SYTO-64, -17, -59, -61, -62, -60, -63 (red).

It is to be understood that the labeling of the probe should not interfere with its ability to recognize and bind to a nucleic acid molecule.

In some embodiments, an analysis intends to detect preferably two or more detectable signals. As described herein, a first probe can interact with the energy source to produce a first signal and a second probe can interact with the energy source to produce a second signal. The signals so produced may be different from one another, but in all cases must be distinguishable from each other, thereby enabling more than one type of unit to be detected on a single target polymer. Use of detection molecules that emit distinct signals (e.g., one emits at 535 nm and the other emits at 630 nm) enables more thorough sequencing of a target polymer since units located within the known detection resolution can now be separately detected and their positions can be distinguished and thus mapped along the length of the polymer.

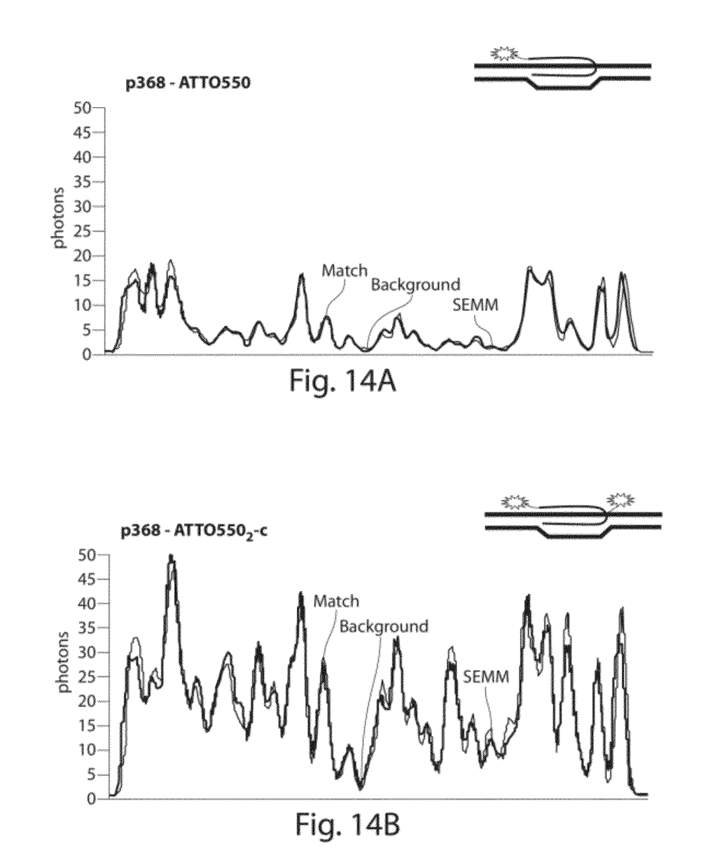

It has been found according to the invention that in some instances it is preferable to use probes having more than one detectable label as this gives rise to stronger signal on an individual nucleic acid target level. It has been further found according to the invention that in such instances the position of the detectable labels, their nature, and the method of attaching them to the probe, including distance to either arm of a bisPNA probe for example, are important. As an example, FIG. 14 demonstrates the difference in optical maps of bacterial artificial chromosome BAC 12M9 using a bisPNA probe carrying a single fluorophore at one end (FIG. 14A) or a bisPNA probe carrying a first fluorophore on one end and a second fluorophore at its center (FIG. 14B). By comparing the experimentally obtained optical map to the known sequence of the target, it is possible to identify those sites that are match sites (i.e., sites having full complementarity to the probe) and those sites that are SEMM sites (i.e., sites having a single end mismatch to the probe). Peaks representative of both are shown in FIG. 14. As will be apparent, both the intensity and number of peaks in the optical map are increased when the doubly labeled bisPNA probe is used in comparison to the singly labeled bisPNA probe. The increase in the number of peaks represents an increase in the number of SEMM sites that are bound by the bisPNA probe, as the sequence has six true complementary sites. The binding of probe to the match sites relative to the binding of probe to the SEMM sites is used as an indication of the specificity of the probe binding. Thus, the probe used in the top panel demonstrates a higher specificity than does the probe used in the bottom panel.

Although not expected prior to the invention, it was found that optical maps that have a higher proportion of peaks resulting from probe binding to mismatched sites such as SEMM sites are still useful and in some instances are actually preferred over those that have no or a low proportion of such peaks. Thus, the optical map shown above in the bottom panel is preferred over the optical map in the top panel, in some embodiments.

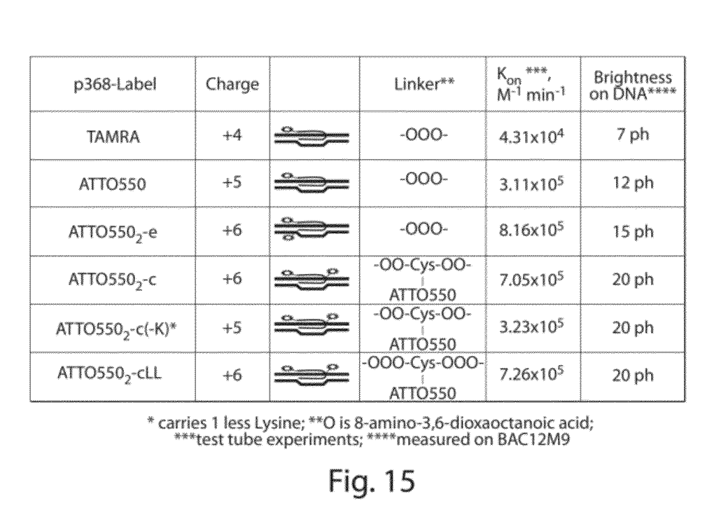

Accordingly, it was determined that in some instances PNA having two or more fluorophores are useful as probes even if they lead to a greater number of peaks that do not represent a true match site. Various multiply labeled probes were then synthesized and tested for their brightness and their specificity (measured as occupancy of match sites relative to occupancy of SEMM sites). The probes shared the same nucleotide sequence and backbone but differed in the type of fluorophore each carried, the position of the fluorophore, and the linker used to attach the PNA arms to each other and to which the fluorophore is attached. The various probes are shown in FIG. 15. The Figure shows data for a probe labeled with a single TAMRA fluorophore (TAMRA), a probe end-labeled with a single ATTO550 fluorophore (ATTO550), a probe end-labeled with two ATTO550 fluorophores (ATTO550₂-e), a probe labeled with one ATTO550 fluorophore at one end and one ATTO550 fluorophore at the center (ATTO550₂-c), a probe labeled with one ATTO550 fluorophore at one end and one ATTO550 fluorophore at the center and having a lysine removed from the PNA (ATTO550₂-c(-K)), and a probe labeled with one ATTO550 fluorophore at one end and one ATTO550 fluorophore at the center using a longer linker between its two PNA strands (ATTO550₂-cLL). The linker chemistry is shown in FIG. 15, with the “O” symbol representing an 8-amino-3,6-dioxaoctanoic acid moiety. It is to be understood that the linker serves to attach the two PNA arms in the bisPNA probe to each other. The linker chemistry therefore relates only to the binding of the center positioned fluorophore and not the end positioned fluorophore.

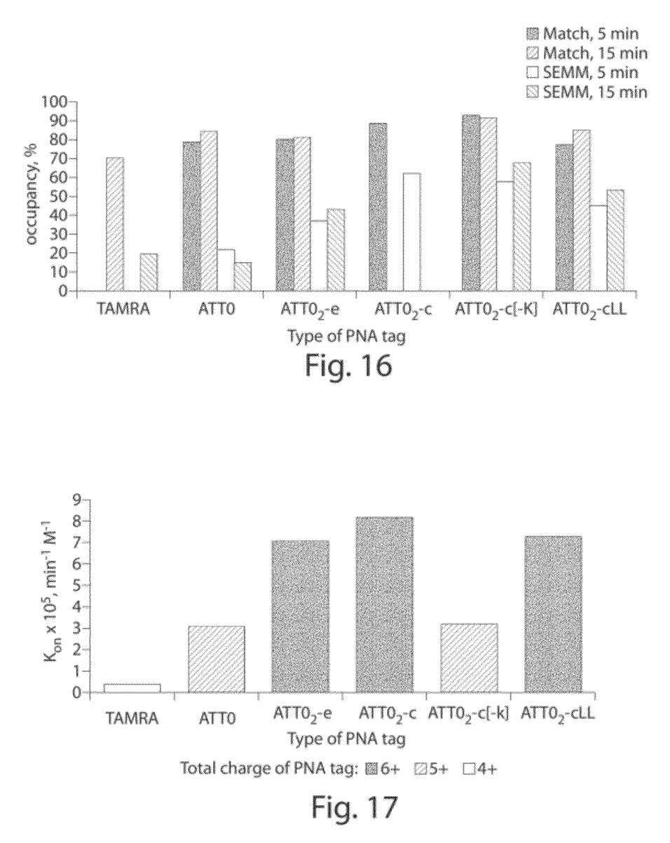

The specificity of these probes is shown in FIG. 16 which shows data relating to the binding of the various probes to BAC12M9 match sites and SEMM sites when hybridization is carried out for 5 and 15 minutes. The specificity of each probe is indicated by the occupancy of match sites relative to SEMM sites. The specificity of PNA probe binding was not affected by hybridization conditions such as time, temperature, and PNA concentration. Instead, specificity appeared to be more a function of the number and position of fluorophores on a bisPNA probe. As an example, the Figure shows that probes with single TAMRA and single ATTO550 fluorophores exhibit a greater specificity than do the other probes tested. However, as indicated by the preceding Table, a greater degree of brightness can be obtained from the doubly labeled ATTO550₂-c, ATTO550₂-c(-K) and ATTO550₂-cLL probes. As a result, some embodiments of the invention preferably obtain and manipulate data derived using bisPNA probes that are both end and center labeled preferably with high-intensity fluorophores, and having at least 4 “O” moieties distancing the two PNA arms. Increasing the length of the linkers from for example 2-3 “O” moieties to at least 4 “O” moieties appears to provide more structural flexibility to the PNA arms, thereby allowing them to interact with and bind to their targets with higher specificity. Some high-intensity fluorophores are defined as fluorophores that emit at least 5, more preferably at least 8, and even more preferably at least 10 photons per fluorophore. In some embodiments, fluorophores having positive charges are useful since when two such fluorophores are present on a probe they will repel rather than quench each other. ATTO550 is one such positively charged fluorophore while TAMRA is a neutral fluorophore that can be quenched when coupled to an identical fluorophore. Another fluorophore that can be used in the dual labeled probes described herein is ATTO647N.

Gel-shift experiments were also carried out to study the binding characteristics of the various probes. Association kinetics measurements were performed by incubating bisPNA (90 nM) with a 383 base pair long DNA fragment (0.6 ng/μl) at 37° C. in TE pH 8.0 containing 20% acetonitrile and 4 mM NaCl. The DNA fragment carrying a single binding site for PNA (located at 42588 position on lambda phage DNA template) was generated by PCR. Following certain incubation times, a 10 μl aliquot of reaction mixture was removed and placed on ice. Gel-shift assay was performed on a 10% acrylamide pre-cast gel with 0.5×TBE as a running buffer followed by staining with SybrGreen I and visualization using ChemiGenius imaging system. FIG. 17 shows that PNA probes display different kinetics determined by the total charge of the probe (PNA and fluorophore combined).

To estimate probe brightness I and site occupancy α, a binding site is selected on the nucleic acid target which is at least 4 kb apart from any other binding site (referred to herein as a stand alone binding site) and a site without binding sites (referred to herein as a background site). The binding site could be a perfect match site or a mismatch site (e.g., SEMM site). It is assumed that (i) each probe emits at least one photon, and that (ii) the probability of having no photons in a bin without probe P_{b}(0) is the same for any background site. This probability can be obtained from photon statistics collected for background bins. As a result, the probability Pₚ(0) for the bin with stand alone probe to have no photons is given by: Pₚ(0)=(1-α)P_{b}(0). Hence the site occupancy a can be calculated as α=1−Pₚ(0)/P_{b}(0). To calculate probe brightness it is assumed that the average number of photons in the bin with stand alone site Iₚ is a sum of the average number of background noise photons I_{b} and of the tag brightness I multiplied by tagging efficiency α. Thus it is possible to calculate the probe brightness as: I=(Iₚ−I_{b})/α.

### Pathogens

The methods of the invention may be used to determine presence or absence of an organism and/or to identify one or more organisms in a sample. The sample may comprise a single organism or it may comprise a mixture of organisms. As will be clear, organisms are detected and identified based on their nucleic acids. The invention intends to detect known and previously unknown organisms or strains of known organisms, such as antibiotic-resistant strains. Samples to be tested in accordance with the invention include biological samples (e.g., stool, urine, blood, etc.), food or beverage samples, biologics and pharmaceuticals as well as samples obtained in the synthesis of biologic and pharmaceuticals, environmental samples, and the like. The type of organism (and mutant strain of organism) that is likely to be detected in the sample will depend upon the nature of the organism.

Specific examples of organisms contemplated or used as biowarfare agents include bacteria and bacterial spores such as B. anthracis (Anthrax and Anthrax spores), E. coli, Gonorrhea, H. pylori, Staphylococcus spp., Streptococcus spp. such as Streptococcus pneumoniae, Syphilis, Yersinia pestis (plague), Vibrio cholera, Clostridia and other toxin producers (botulism), Salmonella, Shigella, and Rickettsia; viruses such as SARS virus, Ebola virus, Hepatitis virus, Herpes virus, HIV virus, West Nile virus, Influenza virus, poliovirus, rhinovirus, vaccinia (smallpox), tularaemia, Marburg virus, Lassa virus, Hanta virus and haemorrhagic fever inducing viruses; fungi such as chlamydia; parasites such as Giardia, and Plasmodium malariae (malaria); and mycobacteria such as M. Tuberculosis.

Further examples of bacteria that can be detected include Streptococcus spp., Staphylococcus spp., Pseudomonas spp., Clostridium difficile, Legionella spp., Pneumococcus spp., Haemophilus spp. (e.g., Haemophilus influenzae), Klebsiella spp., Enterobacter spp., Citrobacter spp., Neisseria spp. (e.g., N. meningitidis, N. gonorrhoeae), Shigella spp., Salmonella spp., Listeria spp. (e.g., L. monocytogenes), Pasteurella spp. (e.g., Pasteurella multocida), Streptobacillus spp., Spirillum spp., Treponema spp. (e.g., Treponema pallidum), Actinomyces spp. (e.g., Actinomyces israelli), Borrelia spp., Corynebacterium spp., Nocardia spp., Gardnerella spp. (e.g., Gardnerella vaginalis), Campylobacter spp., Spirochaeta spp., Proteus spp., Bacteriodes spp., H. pylori, and anthrax.

Further examples of viruses that can be detected include HIV, Herpes simplex virus 1 and 2 (including encephalitis, neonatal and genital forms), human papilloma virus, cytomegalovirus, Epstein Barr virus, Hepatitis virus A, B and C, rotavirus, adenovirus, influenza A virus, respiratory syncytial virus, varicella-zoster virus, small pox, monkey pox and SARS virus.

Further examples of fungi that can be detected include candidiasis, ringworm, histoplasmosis, blastomycosis, paracoccidioidomycosis, crytococcosis, aspergillosis, chromomycosis, mycetoma, pseudallescheriasis, and tinea versicolor.

Further examples of parasites that can be detected include both protozoa and nematodes such as amebiasis, Trypanosoma cruzi, Fascioliasis (e.g., Facioloa hepatica), Leishmaniasis, Plasmodium (e.g., P. falciparum, P. knowlesi, P. malariae), Onchocerciasis, Paragonimiasis, Trypanosoma brucei, Pneumocystis (e.g., Pneumocystis carinii), Trichomonas vaginalis, Taenia, Hymenolepsis (e.g., Hymenolepsis nana), Echinococcus, Schistosomiasis (e.g., Schistosoma mansoni), neurocysticercosis, Necator americanus, and Trichuris trichuria.

Further examples of pathogens that can be detected include Chlamydia, M. tuberculosis and M. leprosy, and Rickettsiae.

The foregoing lists of infections are not intended to be exhaustive but rather exemplary.

### EXAMPLES

### Example 1

Having described various algorithms that may be used to analyze data generated from linear analysis of nucleic acids or other molecules, some experimental results using some of these algorithms are provided below.

As shown in Table 2, eight measured samples of the sequenced strains of S. aureus (table columns) have been compared to theoretically predicted barcodes of 11 sequenced strains (table rows). For each experimental sample the relative log-likelihood of data originating from various strains and corresponding relative probability were calculated. The Table presenting the relative probabilities demonstrates that linear analysis methods of the invention differentiates strains since every experimental strain sample was properly identified.

TABLE 2

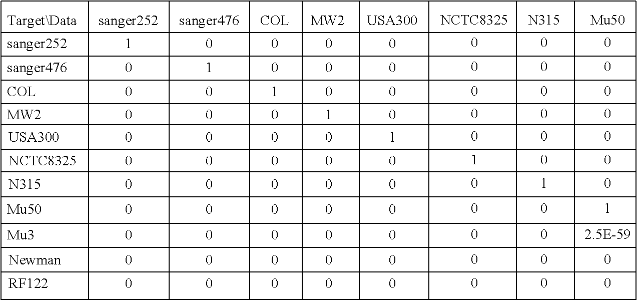

Table 3 shows the same relative probabilities of data originating from a sequenced strain, but re-calculated on per nucleic acid basis. This representation of the data-to-genome metric highlights similarities between strains. Thus one can see high similarity between strains Mu50 and Mu3, Mu50 and N315 and some similarity of strains USA300 and MW2.

The following color coding of relative probabilities is used in both Tables: unshaded: 0.0-0.05; lightly shaded: 0.05-0.3; and darkly shaded: 0.3-1.0.

TABLE 3

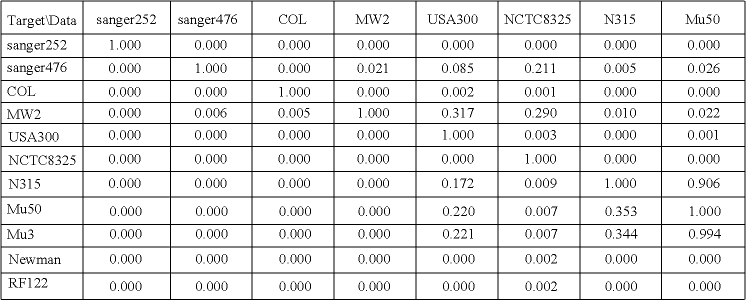

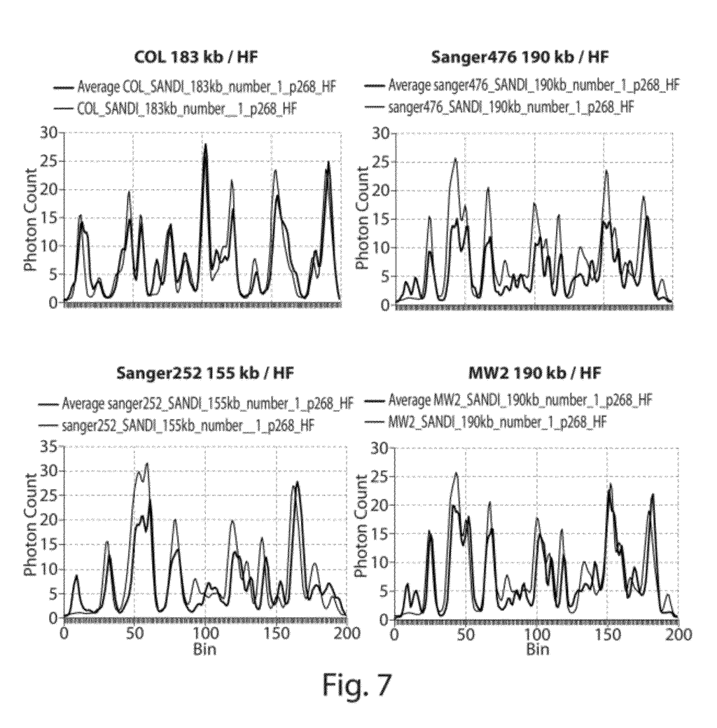

FIG. 7 shows the observed average traces for various strains superimposed on the theoretical traces (or templates) for these strains. Each graph shows the theoretical trace for a strain and the average observed trace.

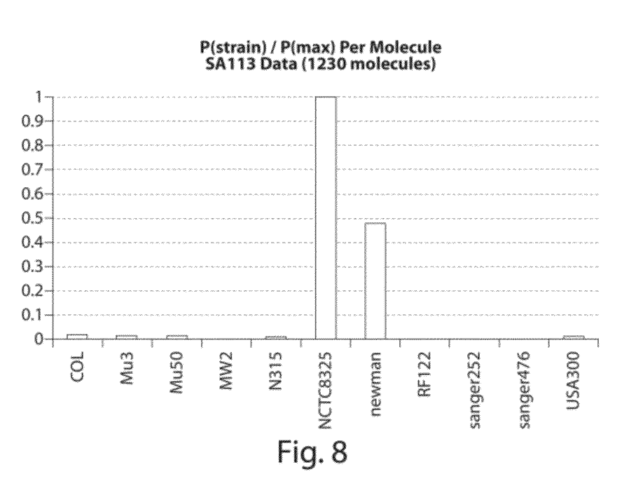

FIG. 8 shows the measured data from unsequenced SA113 sample being compared to 11 sequenced strains of S. aureus. The sample has the highest probability to be originated by NCTC8325.

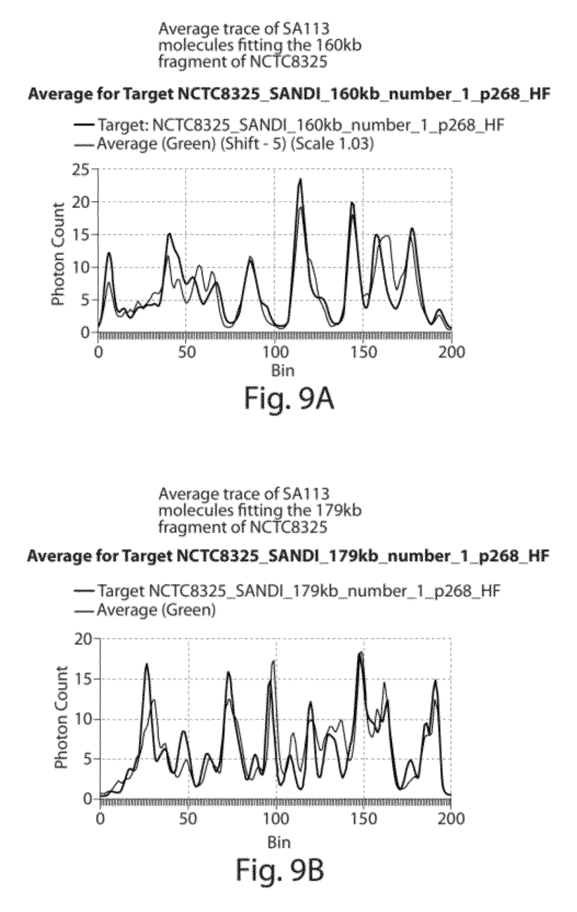

FIG. 9 illustrates the similarity of certain fragments of SA113 to theoretical NCTC8325 traces.

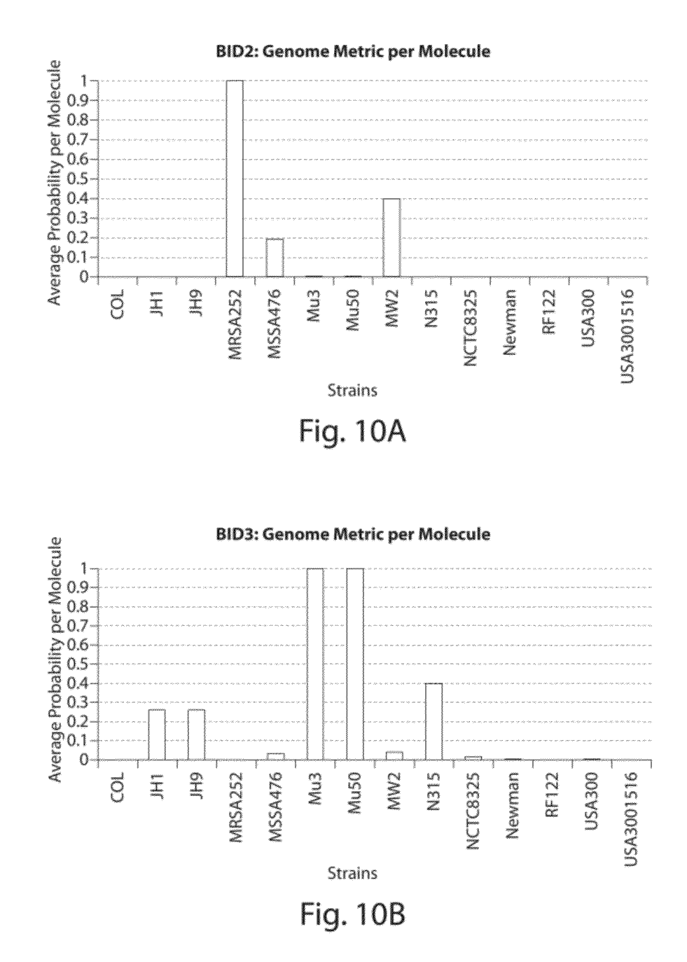

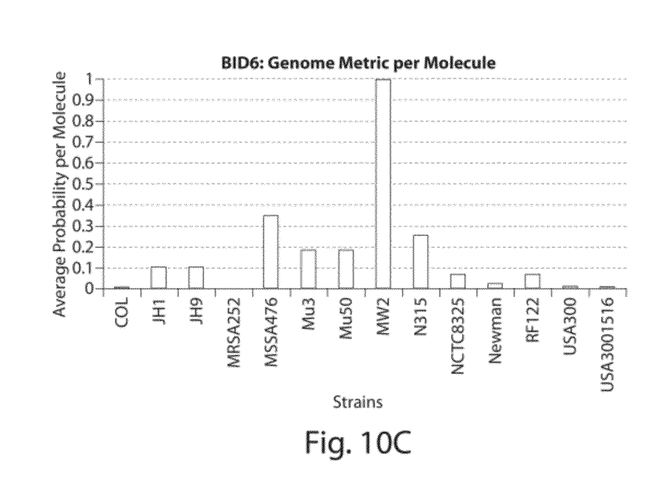

FIGS. 10A-C show the relative probability, represented as bar graphs, of a known strain being the source of an unsequenced observed strain. The higher bar corresponds to the most similar genome. Three unsequenced strains of S. aureus exhibit similarity to different strains of S. aureus: BID2 exhibits similarity to MRSA252 and MW2; BID3 exhibits similarity to Mu3 and Mu50; and BID6 exhibits similarity to MW2.

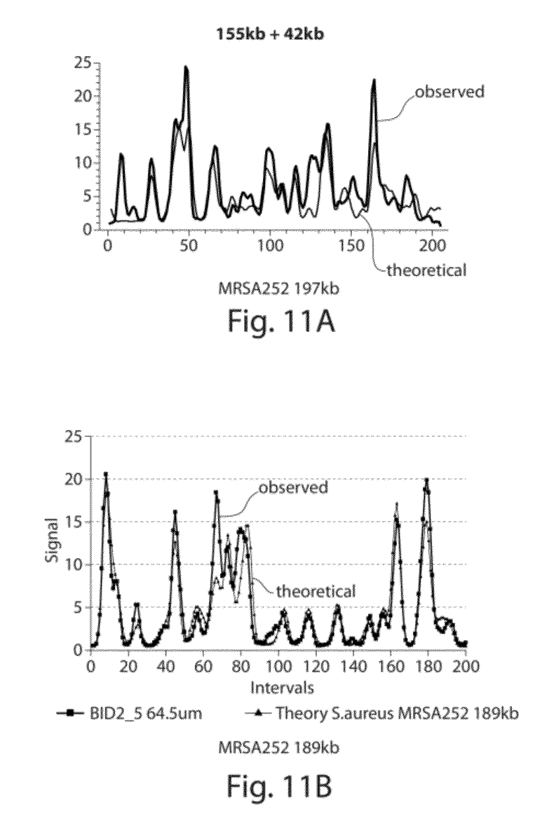

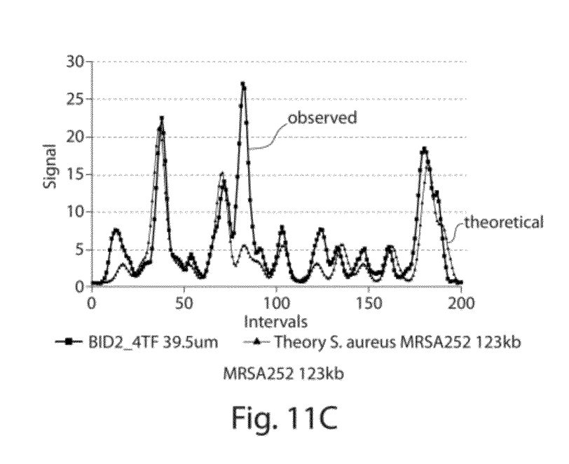

FIGS. 11A-C show the traces of various BID2 fragment lengths overlayed on the theoretical traces of corresponding fragments of MRSA252.

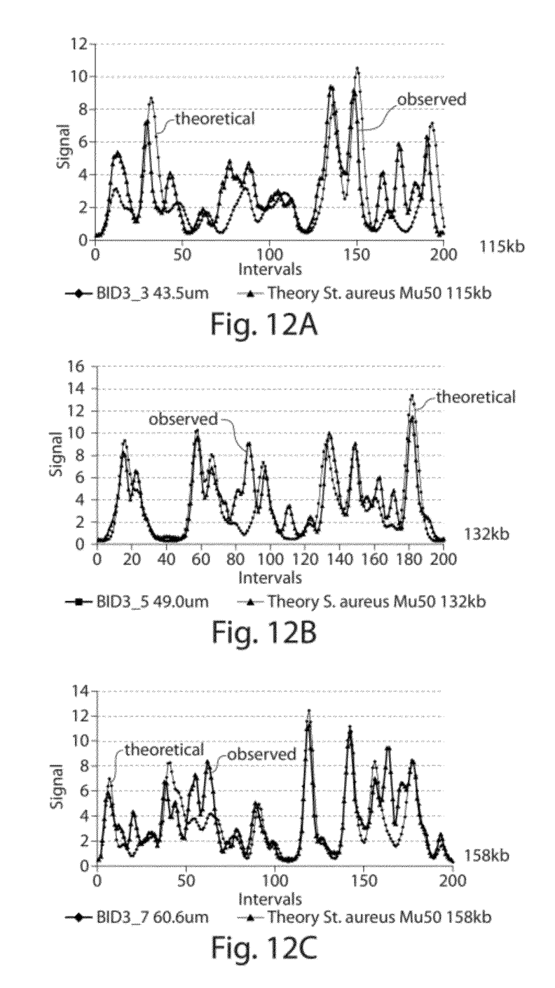

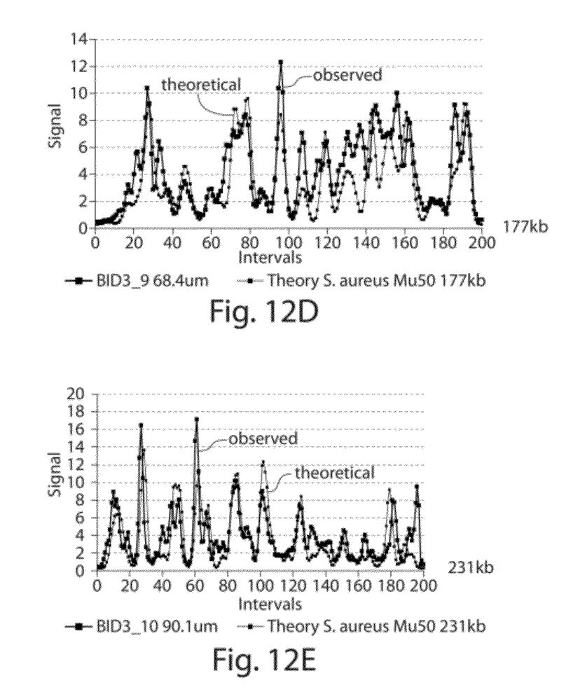

FIGS. 12A-E show the traces of various BID3 fragment lengths overlayed on the theoretical traces of corresponding fragments of Mu50.

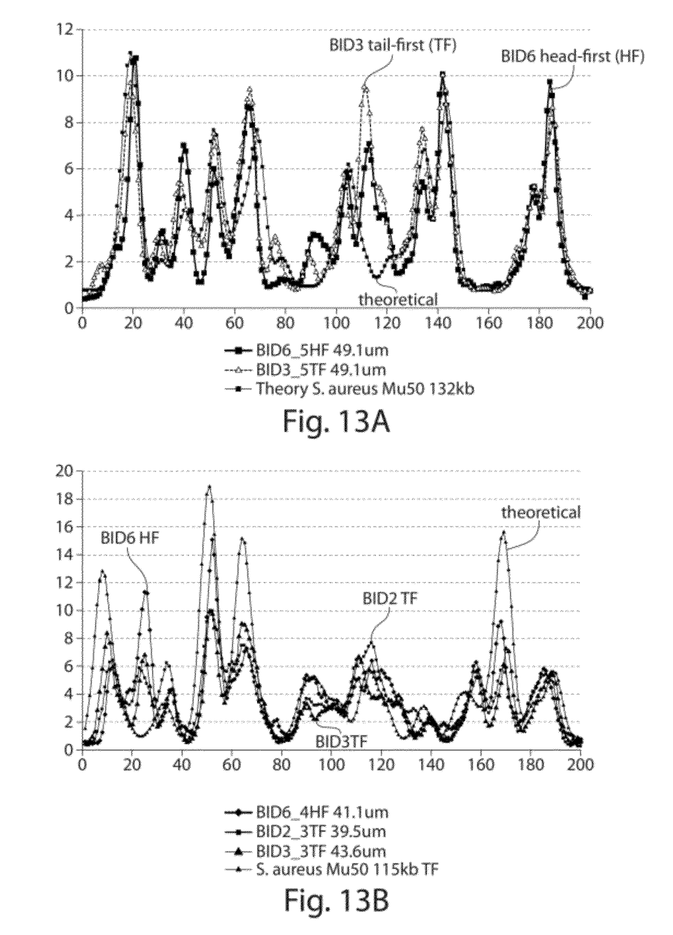

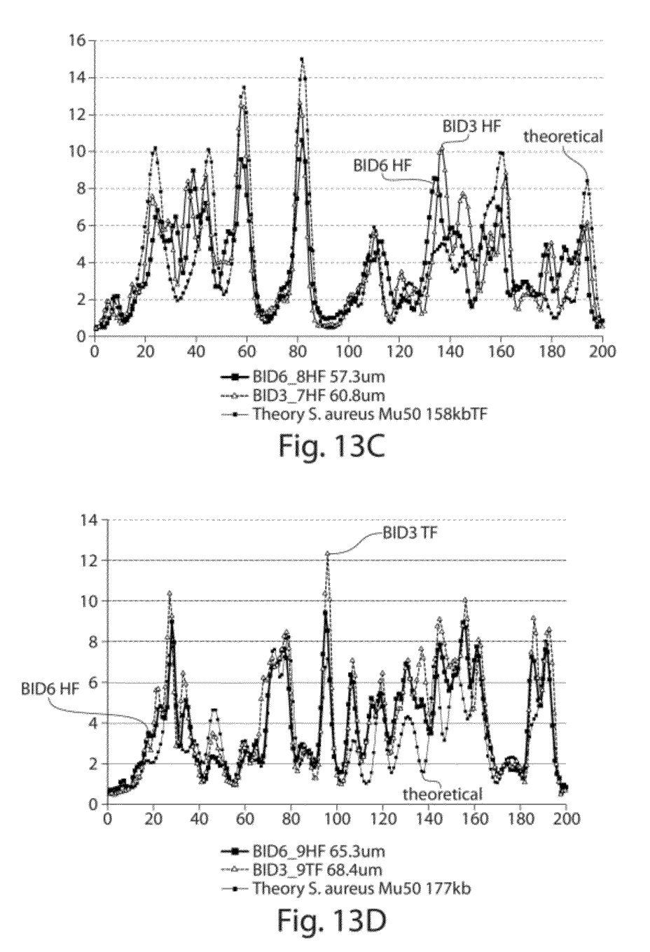

FIGS. 13A-D show the traces of various BID3 and BID6 fragment lengths overlayed on the theoretical traces of corresponding fragments of Mu50.

### Example 2

### Materials and Methods

General design of PNA tags (Panagene, Korea) was (N)-Dye-OO-K-K-YYYYYYYY-OOO-yyyyyyyy-K-K (SEQ ID NO:1), where Y is a T (thymine) or a C (cytosine) on a Watson-Crick strand and y is a T or a J (pseudoisocytosine) on a Hoogsteen strand, which is symmetric to the Watson-Crick strand; O and K stand for 8-amino-3,6-dioxaoctanoic acid and a lysine, respectively. The following notation was used to refer to PNA sequence: p58 stands for a tag which Watson-Crick strand carries Y=T in all positions other than 5 and 8, where Y=C, i.e. (N)-TTTTCTTC; Hoogsteen strand has J's in the corresponding positions. Fluorescent dyes were tetramethylrhodamine, or ATTO550 and ATTO647N (ATTO-TEC, Siegen, Germany). Throughout the text, identity of the fluorophore is indicated following the tag sequence, for example p58T stands for p58 labeled with tetramethylrhodamine, p368A is p368 labeled with ATTO550. Table 4 shows the structures of these PNA tags.

TABLE 4

| PNA name | PNA sequence^{a} | Charge |
|---|---|---|
| p58T | TMR-OO-K-K-TTTTCTTC-OOO-JTTJTTTT-K-K | 4+ |
| | (SEQ ID NO: 2) | |
| p58A | Cys(ATTO550)-OO-K-K-TTTTCTTC-OOO-JTTJTTTT-K-K^{b} | 5+ |
| | (SEQ ID NO: 3) | |
| p58Ar | Cys(ATTO647N)-OOO-K-K-TTTTCTTC-OOO-JTTJTTTT-K-K^{c} | 5+ |
| | (SEQ ID NO: 4) | |
| p368A | Cys(ATTO550)-OO-K-K-TTCTTCTC-OOO-JTJTTJTT-K-K | 5+ |
| | (SEQ ID NO: 5) | |
| p268A | Cys(ATTO550)-OO-K-K-TCTTTCTC-OOO-JTJTTTJT-K-K | 5+ |
| | (SEQ ID NO: 6) | |
| p358Ar | Cys(ATTO647N)-OO-K-K-TTCTCTTC-OOO-JTTJTJTT-K-K | 5+ |
| | (SEQ ID NO: 7) | |

^{a}PNA sequences are reported from N to C terminus
^{b}ATTO dyes are attached post-synthesis to a Cys at the N terminus by thio chemistry
^{c}Longer linker was the result of optimization for binding specificity.

Intercalated DNA molecules with hybridized tags were directly introduced into a microfluidic chip, where they were stretched and conveyed to the detection zone for single-molecule mapping. The fused silica chip manufactured by Micralyne Inc. (Edmonton, Canada) used in this study was described in Mollova et al., 2009, Anal. Biochem., 391:135-143. Measurements were performed at a linear flow rate of ˜12 μm/ms, and data was recorded at 20 kHz.

Emission of ATTO550 and tetramethylrhodamine fluorophores was excited by laser light at 532 nm wavelength (green), ATTO 647N at 633 nm (red), and POPO-1 at 445 nm (blue). To avoid cross-talk between the different color fluorescence, the interrogation spots were separated. The sequence of the spots was blue (first intercalator fluorescence), green (tag), red (tag), and blue (second intercalator fluorescence). The green, red, and second blue spots were displaced from the first blue spot by 5, 10, and 28 μm, respectively. The distance between the first intercalator spot and the stretching taper was 40 μm.

Data processing involved locating DNA events in the data stream, forming clusters of similar molecules, and then comparing their averages to theoretical predictions. Each of these steps was performed with software having logic described below. Briefly, the first software package located DNA events by identifying correlated signals between the two intercalator laser spots, determined the velocity, average intensity, and length of each molecule, and associated the tag signals with each event. We selected molecules with the lengths in the range between 50 and 100 μm for further analysis. The traces were then interpolated and filtered for defects.

Retained molecules were analyzed with sorting software which employed several iterative stages of clustering similar molecules. Each cluster produced an average oriented map which was then corrected for the distortion caused by the accelerated movement of long DNA fragments during detection. This was achieved by finding the correction that results in an optimal correspondence between average maps of head-first and inverted tail-first maps of the same fragment.

The data analysis algorithms are described in more detail now.

Single-molecule maps. Single molecule DNA traces were located in the data stream using a software that identified correlated signals between the two laser light beams that excite intercalator fluorescence. The length, velocity, average intensity, and tag signal of each molecule were extracted as described in Phillips et al., 2005, Nucleic Acids Research, 33:5829-5837 and Larson et al., 2006, Lab Chip, 6:1187-1199. The software was redesigned to efficiently handle many data bins (10⁸) and large numbers of molecules (10⁵). A two stage algorithm was added to improve the accuracy of locating the start and end of the backbone of each molecule. First, each molecule's ends are located by transitions of the backbone signal across a predefined intensity threshold. This is done for the signal of each backbone spot after it has been smoothed using local averaging over a 0.17 ms window. Second, the locations of the molecule's ends are refined by finding the closest threshold crossing in the original, unsmoothed data. The current implementation also determines molecule position and velocity using these ends (rather than the “center of mass of the signal” (Larson et al., 2006, Lab Chip, 6:1187-1199). This design is frequently less sensitive to backbone intensity fluctuations for well-stretched molecules.

Identification of average maps. The data analysis to cluster similar molecules was a multistep process, starting with interpolation and filtering of single-molecule traces. Interpolation facilitated the comparison of molecular traces by transforming the data associated with each molecule from uniform time bins, which varied in number depending on the length and velocity of each molecule, onto a regular grid of 200 intervals for every molecule.

Filtering involved excluding molecules that were unlikely to be identified due to hairpin conformations, overlapping, or spurious contaminants with bright fluorescence detected simultaneously with the DNA molecules. Contaminants were identified by anomalous brightness in the tag detection channel, and DNA molecules were excluded if the number of photons in any bin detected in that channel exceeded the threshold of 200 photons, which was about 5-fold stronger than the expected maximal peak intensity. Folded and overlapped molecules were characterized by a step-like intensity profile of intercalator fluorescence. They were excluded if the intercalator fluorescence intensity surpassed a threshold of 1.8 times the median value for that molecule over three or more consecutive bins. The parameters for all filters were determined empirically.

The molecules passing filtration were then grouped into clusters to identify average restriction maps. The software was written to perform k-means clustering (Duda et al., Pattern Classification, John Wiley & Sons, 2001) over several stages. Initially, we employed a rank-based metric to evaluate the similarity of each pair of molecules expressed as a molecule-to-molecule distance based on length and trace similarity. This rank metric between two traces is similar to Spearman's rank correlation coefficient (Rₛ) (Kendall, Rank Correlation Methods, Griffin, 1962), and defined as

$${R}_{s} = \frac{1}{{N}^{2}} {\sum }_{i} \vert {a}_{i} - {b}_{i} \vert$$

where N is the number of intervals and ai and bi are the ranks of the intensity of interval i within all intervals of traces a and b correspondingly.

To group molecules into clusters, the molecule with the closest n nearest neighbors on average was selected as a center of a potential cluster with n being an adjustable parameter. This molecule and its n nearest neighbors were declared a cluster. This procedure was repeated until all molecules were divided into preliminary clusters of n+1 molecules. Preliminary clusters with similar averages were merged to avoid multiple clusters originating from the same DNA fragment. Average traces of the resulting clusters were used as seed templates for clustering in a second clustering stage. For this stage, trace-to-seed template distances were defined as 1−c(i,j), where c(i,j) is the correlation coefficient of the i-th trace and j-th seed template. The clustering was performed iteratively until convergence criteria were met (see Duda, 2001), with cluster averages from each iteration used as seed templates for the following iteration. The final clustering step employed a probability distance metric based on intensity probability distributions generated for each interval along the template for each cluster. As a result of this clustering, we obtained a set of average trace maps for each restriction fragment present.

Acceleration correction. In some cases, the resulting trace average included non-linear distortions of position along the DNA caused by molecule acceleration in the stretching funnel during detection. This occurred if the length of a DNA fragment exceeded the distance between the stretching funnel and the excitation light spot. We corrected the dominant harmonic term of this distortion by optimizing the correlation between head-first and inverted tail-first pairs of the same fragment. Acceleration distortion, δ, was described as a shift of the trace along the coordinate, x, of the measured trace of length L:

δ(x)=α sin(πx/L).

The optimal acceleration coefficient, α, was determined by maximizing the correlation, expressed as a continuous dot product, C, of head-first, H(x), and tail-first, T(x), traces:

$$C = {\int }_{x = 0}^{L} ( H ( x + δ ( x ) ) - \overline{H} ) ( T ( L - x + δ ( L - x ) ) - \overline{T} ) d x ,$$

where H̅ and T̅ are the average head-first and tail-first trace intensities, respectively. The resulting HF-TF averages corrected for the acceleration distortion were exported for further comparison with theoretical averages.

The correlation coefficient between HF and iTF traces (R) was calculated using following formula:

$$R = \frac{{\sum }_{i = 1}^{N} ( {h}_{i} - \overline{h} ) ( {t}_{i} - \overline{t} )}{\sqrt{{\sum }_{i = 1}^{N} {( {h}_{i} - \overline{h} )}^{2} {\sum }_{i = 1}^{N} {( {t}_{i} - \overline{t} )}^{2 }}} ,$$

where hᵢ and tᵢ are photon counts per bin i for HF and iTF traces, respectively, N is the number of intervals, and h̅ and t̅ are the average head-first and tail-first trace intensities.

Generation of theoretical maps. Theoretical maps of restriction fragments were generated from the known sequences of restriction fragments by populating various PNA binding sites. We allowed tags to hybridize to exactly matching sites and sites with a single mismatch at one of the termini (SEMM) (Phillips et al., 2005, Nucleic Acids Research, 33:5829-5837; Chan et al., 2004, Genome Research, 14:1137-1146). Binding probabilities for exact and SEMM sites were varied to optimize the match between the experimental and the theoretical trace averages. These were set at 85% and 10-40%, respectively. In general, the optimally matching values vary with experimental conditions.

We also included in the model additional physical effects that determine the shape of theoretical DNA traces to reproduce experimental observations. To account for limitations of optical resolution and variability of stretching length, the map resolution was set at 5 kb. Additional noise from scattered light and random tags (either free ones left after cleaning or the ones randomly attached to the DNA fragment) is included in the theoretical trace as a random uniform signal. The final trace is then scaled to match the experimental average in both length and signal brightness.

### Results

This Examples presents a fast approach for mapping bacterial genomes which combines an automated preparation of genomic DNA samples, measurement of maps based on sequence-specific tags bound to DNA and clustering of molecules into oriented maps of restriction digest fragments. DNA samples are 150 to 250 kb fragments of genomic DNA generated by a rare-cutting restriction endonuclease and hybridized with fluorescent PNA tags. Optical traces of DNA fragments are obtained using DLA, where intercalated DNA fragments are unwound in accelerated flow on a microfluidic chip and measured one at a time using a confocal optical scheme (Chan et al., 2004, Genome Research, 14:1137-1146; Phillips et al., 2005, Nucleic Acids Research, 33:5829-5837; Mollova et al., 2009, Anal. Biochem., 391:135-143).

Direct Linear Analysis (DLA) ready samples were produced using an automated system with a membrane-based mini-reactor. Genomic DNA was extracted from cells, purified, digested with a restriction enzyme, and tagged with sequence-specific fluorescent PNA probes. The sample was then eluted and stained with intercalator whose fluorescent emission is spectrally resolved from that of the tags. The design of the mini-reactor and sample preparation protocols were optimized to produce DLA-quality DNA in 150-250 kb range, pure and with minimal damage to ensure efficient tagging and stretching.

The DNA sample was injected into the microfluidic device for DLA, where traces of multiple DNA fragments were detected. The fragment lengths were determined using the fluorescence of DNA-bound intercalator molecules. Fluorescent PNA tags bound to DNA in a sequence-specific manner produced unique optical maps of these fragments. Their oriented maps were obtained by software using a clustering algorithm as described herein. Bacterial genomes can be identified by comparing experimental maps to theoretical maps generated from completed sequences or to previously measured experimental maps.

DLA mapping of microbial genomes. DLA provides two layers of information—lengths of the restriction fragments and maps of motif-specific tags hybridized to the fragments. The length of a restriction fragment is a contour length (the length per nucleotide times the number of nucleotides) of the fragment. The measured length is the length of the molecule projection on the movement direction. The measured and contour lengths are equal for 100% stretching. The DLA-measured contour length differs from the B-form DNA due to intercalation (Larson et al., 2006, Lab Chip, 6:1187-1199). The fragment lengths and average intensity of intercalator fluorescence can be revealed in a density DLA plot. In these coordinates, molecules stretched to their contour lengths form clusters appearing along abscissa at a constant level of intercalator fluorescence intensity (Chan et al., 2004, Genome Research, 14:1137-1146; Larson et al., 2006, Lab Chip, 6:1187-1199). As the clusters are formed by DNA fragments of equal lengths, they directly correspond to the bands of PFGE measured for the same sample. A few hundreds of copies of a fragment are sufficient to determine its length by DLA. For a typical sample of single bacterial strain, such as a clinical isolate, an adequate data set can be accumulated within 20-40 minutes. Therefore, DLA sizing is more sensitive and faster than PFGE; resolution of DLA sizing is similar to that of PFGE.

In addition to sizing, DLA provides maps of specific tags hybridized to the DNA fragments, based on the distinct underlying genomic sequences of microorganisms. Therefore, fragments with similar lengths but different sequences can be distinguished in DLA. Obtaining these maps from the measured optical data is a multistep process. This has been demonstrated for an isolated cluster of the molecules containing a single 193 kb fragment of an E. coli K-12 chromosome digested with NotI restriction endonuclease and labeled with p58A tag. The molecules with lengths between 68 to 73 μm were selected for the analysis. We then exclude from the analysis the molecular traces that are unlikely to be identified due to different defects.

First, we exclude DNA molecules with incorrectly calculated velocities. This happens when a molecule traveling through the first detection spot is confused with a different molecule in the second spot. In this case, the time of flight between the spots is determined incorrectly leading to an error in length and tag positions. We eliminate these traces by only selecting DNA molecules with velocities falling within a 3 μm/ms window of the maximum on the velocity distribution histogram. Second, we exclude DNA molecules with very strong fluorescent spikes due to impurities or aggregated tags. Finally, we exclude folded and overlapped molecules. Their profiles are identified by a step-like increase of the intercalator fluorescence intensity due to an overlap of the signals from the two DNA strands (molecule with a hairpin). We refer to the intercalator fluorescence intensity filter as a DNA conformation filter. Typically, velocity, tag intensity, and DNA conformation filters exclude 3-10%, <1%, and 25-50% of selected molecules, respectively. In this Example, the cluster selection included 1278 molecules, of which 110, 9, and 466 molecules were excluded by molecule velocity, tag intensity, and DNA conformation filters, respectively, leaving 693 molecules for analysis.

We sorted the remaining 693 selected molecules using the clustering algorithm to identify the groups of similar traces. As expected, two clusters of optical maps were identified and their respective maps were obtained by averaging. These maps correspond to the populations of molecules traveling in the opposite—head-first (HF) and tail-first (TF)—orientations. Statistically, if the number of the molecules is large enough, half of the fragments should be detected in a head-first and the other half in the tail-first orientation. In this Example, the molecules were split 54.5% and 45.5% between the two clusters. Typically, the inequality of the numbers of molecules belonging to the two clusters corresponding to two orientations is no more than in this Example. Note that the sorting algorithm does not necessarily find only two clusters even in the case when there is only one fragment expected for the selection (see examples below). Even in this instance, however, the clusters identified for the pair of orientations should be of approximately the same size.

To facilitate the comparison, we overlap the HF oriented map with the inverted tail-first (iTF) oriented map. The similarity between the patterns is clear based on the order of the peaks, their grouping and relative intensities; however, the positions of the peaks along the maps differ for two the two orientations. The distortion is due to non-constant velocity of molecules when passing through the detection spot. This happens when the length of the molecule exceeds the distance between the stretching taper and light spot, which excites fluorescence of the tags. In this case, when the detection of the molecule head started, its tail was still in the funnel, surrounded by flow moving at slower rate than within the constant cross-section interrogation channel, and the molecule was accelerating. We corrected for acceleration to eliminate the distortions of the peak positions. The same empirically determined parameter was applied to both orientations and corrected maps now show remarkable similarity to each other with the correlation coefficient of 0.979. Similarity of the HF and iTF maps as well as of the relative numbers of the molecules allocated to these clusters are the internal controls routinely used in our analysis. In the case of sequenced organisms, we can also compare the experimental maps with the maps calculated from the sequence of genomic DNA by populating different PNA binding sites.

To characterize robustness of the map analysis, we assessed the effect of selection of molecular traces on reproducibility of the maps. We used the same cluster of molecules corresponding to the 193 kb long fragment of E. coli NotI restriction digest and made 4 different selections. The total number of molecules selected varied with the width of length selection. A large fraction of molecular traces are excluded from every selection by the DNA conformation filter. In fact, there were too few molecules after filtering in a 1 μm wide selection for statistically significant analysis. The rest of the selections were successfully sorted into the clusters of oriented maps. Notably, when the whole selection is processed without DNA conformation filtering, 20-30% of the molecules were assigned neither to HF, nor to TF orientations of the 193 kb fragment; rather they formed a separate low-correlation group(s). Therefore, a considerable proportion of the molecules that would be excluded by conformation filtering is not used to obtain the maps anyway. Maps of the restriction fragments produced from the data sets with and without filtering are the same and also do not depend on selection. The evident improvement in correlation between HF and iTF may be due to a larger number of molecules employed in the analysis of the wider range of lengths. The DLA maps presented were obtained following DNA velocity, fluorescence intensity, and conformation filtering.

Analysis of clusters containing more than one fragment is more challenging, but demonstrates the added resolution of this approach compared to conventional fragment sizing techniques alone. We analyzed a cluster of molecules centered at 77 μm comprising two E. coli NotI restriction digest fragments—208 kb and 214 kb. Three selections of molecular traces in 2 μm wide slices were analyzed. The sorting algorithm identified at least 4 groups of molecules corresponding to two orientations of both fragments in every selection. Relative abundance of each fragment varies with the length of the selected molecules—both fragments are equally represented in the middle selection, while 208 kb and 214 kb fragments prevail in shorter and longer selections, respectively. The number of molecules classified as neither of the fragments was less than 10% in every selection. Quality of the maps, as judged by HF-iTF correlation, is better when a higher number of molecules is associated with the fragment. Combining the analysis of the three sections, a total of 515 and 735 molecules were assigned to the 208 kb and 214 kb fragments, which compares well with 549 and 763 molecules in the analysis of the whole 6 μm wide selection at once.

Thus, in summary, different selections of molecule lengths ranging in width from 1 to 7 μm, result in similar oriented maps as long as there are enough molecules for statistically significant analysis. Larger number of molecules sorted into the cluster leads to improved correlation between HF and iTF traces due to better noise cancelation. We also noted, that the large fraction of traces that would be excluded from every selection by a conformation filter form a separate low-correlation cluster and do not affect the average maps. The analysis was performed on selections representing 1 or 2 fragments resulting in 2 or 4 average oriented maps, respectively.

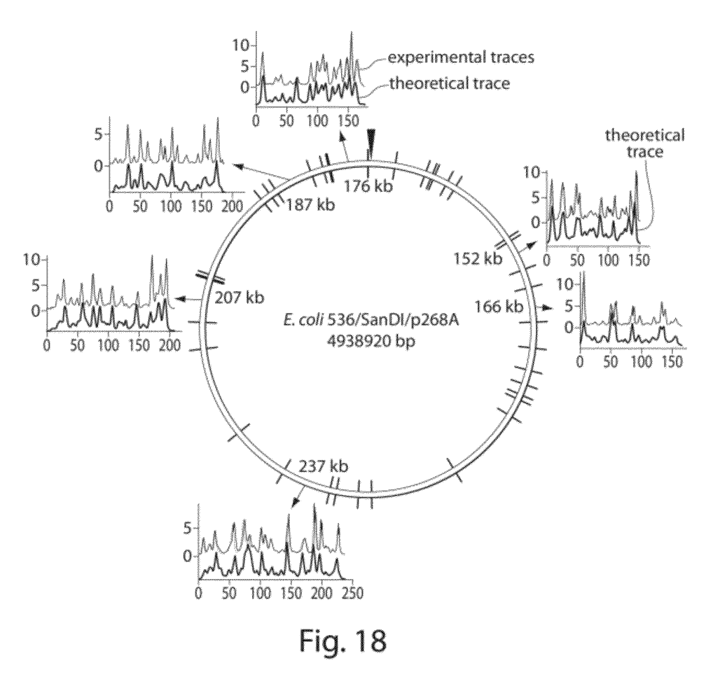

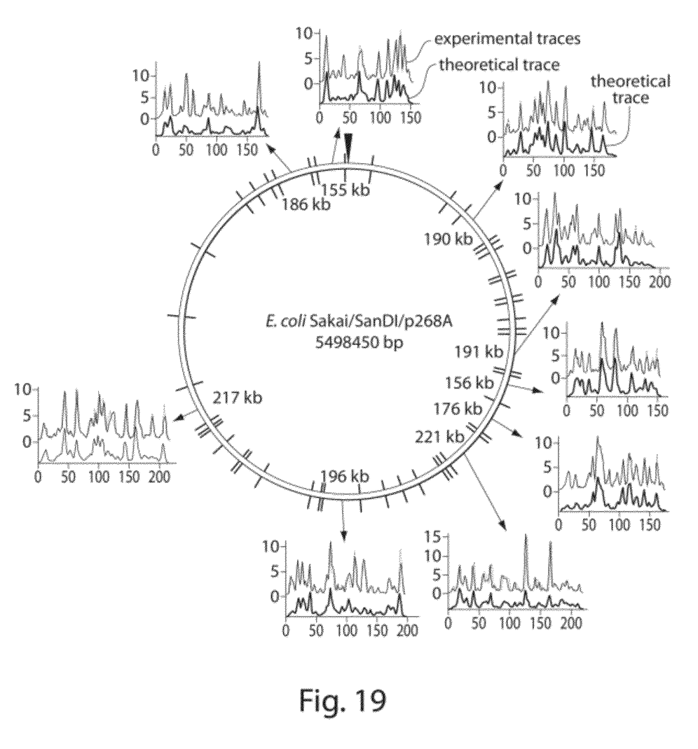

Clusters comprised of both single and multiple fragments are encountered in analysis of bacterial genomes. Digestion of E. coli 536 with SanDI results in 6 clusters within the range of the best DLA performance between 150 kb and 250 kb. As expected from the sequence, each cluster arises from a single fragment. For example, analysis of a cluster centered at 78 μm yields a map which is consistent with a map calculated from the sequence of a 207 kb fragment. Restriction digest of E. coli O157:H7 Sakai shows 4 clusters. Analysis of a cluster at 67 μm results in 4 fragments each of which was found by pairing corresponding HF and iTF orientations obtained by the sorting software. The correct identity of each fragment was confirmed by comparison of its experimental map to the map calculated from the fragment sequence. Notably, DNA fragments comprising cluster at 67 μm are not resolved using PFGE, but all of them were individually identified by DLA. Complete DLA maps of E. coli 536 and E. coli O157:H7 Sakai are shown in FIGS. 18 and 19, respectively.

Reproducibility of experimental traces and comparison with theory. To evaluate reproducibility of DLA mapping, we performed three experiments with independent sample preparations. The maps obtained by averaging of the HF and iTF oriented maps for every fragment are in a very good agreement in the positions, shapes, and relative intensities of all major peaks. There are minor discrepancies of two types. First, there are minor peaks—overlapping with other peaks or stand-alone—in some experiments that are absent in others. These distortions are probably due to variability in tag binding to matched sites as well as less frequent binding to mismatched sequences, predominantly with a mismatch at one of the termini (single-end-mismatch, SEMM) [24]. Second, there is variability in the position of some peaks (black arrows). This effect is observed only for long fragments, which travel with acceleration during detection, and is the result of incomplete acceleration correction (FIG. S8). Variation in the peak position generally does not exceed 1 μm.

Fluorophores with varying brightness or different color can be attached to PNAs. To evaluate potential influence of tag chemistry, we obtained maps with tags that recognize the same motif, but carry tetramethylrhodamine, ATTO550 or ATTO647N fluorophores. Since these tags differ in their total electrostatic charges (Table 4) they display different binding to targets on DNA. The tagging protocol has been adjusted to obtain similar levels of match and SEMM site occupancy for the two tags. (See Table 5.) Optical traces for all three fluorophores are similar (positions, shapes, and relative amplitudes of peaks and valleys) with a pronounced 2-fold increase in signal intensity when ATTO dyes are used.

TABLE 5
Mini-reactor automated protocols for preparation of bacterial genomic DNA for DLA

| | | | | | Duration^{c}, |
|---|---|---|---|---|---|
| Step^{a} | Mode | Buffer^{b} | Reagents^{c} | T, ° C. | min |
| 1 | wash | 0.1xLB: 5 mM Tris-HCl pH 8, 5 mM EDTA, 0.05% Tween20, | | 37 | 5 |
| | | 0.05% Triton X-100 | | | |
| 2 | injection | LB: 50 mM Tris-HCl pH 8, 50 mM EDTA, 0.5% Tween20, | lysozyme 950 (100) μg | 37 | 4 |
| | | 0.5% Triton X-100 | lysostaphin 100 (none) μg | | |
| | | | Achromopeptidase 1000 U^{b} | | |
| | | | RNase 5 ng | | |
| 3 | incubation | | | 37 | 30(20) |
| 4 | wash | TE/SDS: 10 mM Tris-HCl pH 8, 1 mM EDTA, 0.1% SDS | | 37 | 4.8 |
| 5^{d} | injection | PKB: 50 mM Tris-HCl pH 8, 10 mM EDTA, 1% SDS, 2% | proteinase K 500 (200) μg | 37 | 4.8 |
| | | β-mercapto ethanol | | | |
| 6 | incubation | | | 55 | 32(17)^{e} |
| 7 | wash | TE/SDS: 10 mM Tris-HCl pH 8, 1 mM EDTA, 0.1% SDS | | 37 | 4.8 |
| 8 | wash | TE/NaCl: 10 mM Tris-HCl pH 8, 1 mM EDTA, 200 mM NaCl | | 37 | 6.3 |
| 9 | incubation | | | 37 | 6.4 |
| 10 | wash | RE buffer | | 37 | 7.3 |
| 11 | injection | RE buffer | NotI, SanDI or ApaI 100-500 U | 37 | 4 |
| 12 | incubation | | | 37 | 21 |
| 13 | wash | TE/EDTA: 10 mM Tris-HCl pH 8, 20 mM EDTA | | 37 | 12 |
| 14 | wash | TE: 10 mM Tris-HCl pH 8, 1 mM EDTA | | 37 | 6.3 |
| 15 | injection | TE: 10 mM Tris-HCl pH 8, 1 mM EDTA | PNA, 0.2 nmoles | 37 | 10 |
| 16 | incubation | | | 55 or 65^{f} | 18^{e} |
| 17 | wash | TE/NaCl: 10 mM Tris-HCl pH 8, 1 mM EDTA, 200 mM NaCl | | 37 | 22 |
| 18 | incubation | | | 65 | 12^{e} |
| 19 | wash | TE/NaCl: 10 mM Tris-HCl pH 8, 1 mM EDTA, 200 mM NaCl | | 37 | 6.7 |
| 20 | wash | TE: 10 mM Tris-HCl pH 8, 1 mM EDTA | | 37 | 15 |

^{a}Automated protocol also includes priming mini-reactor (5 min), sample injection (7 min), preparation of the mini-reactor for elution (5 min), and elution (10 min)
^{b}Abbreviations: LB, lysis buffer; TE/SDS, TE buffer with SDS; PKB, proteinase K buffer; TE/NaCl, TE buffer with NaCl; RE buffer, buffer supplied with restriction enzyme; TE/EDTA, TE buffer with extra EDTA.
^{c}Reagents and step durations used for E. coli are shown in parenthesis if different from S. epidermidis preparations.
^{d}This step includes separate injections of PK buffer followed by injection of reagent; time shown includes both.
^{e}High temperature incubation steps are followed by 2 min cool down steps; time shown includes both.
^{f}Temperature during PNA hybridization was set to 55 or 65° C. for ATTO-labeled and TMR-labeled probes, respectively.

Experimental maps are in very good agreement with theoretical maps calculated from the sequences of 193 and 208 kb fragments. All major peaks were predicted by calculations. Several differences include the peaks with misrepresented amplitude or the peaks completely missed in calculations. Deviations of calculated traces from experiment can result from incorrect assignment of occupancies for different types of mismatched binding sites or enhanced binding of PNAs to targets positioned in close proximity of each other (extended P-loops). The latter binding mechanism is difficult to model due to the complexity of interactions involved.

Choice of signal-generating pair. Different combinations of restriction enzyme and sequence-specific tag, which constitute a signal-generating pair (SG pair), can be used to probe various bacterial genomes. The components of SG pairs can be optimized independently for different applications.

Freedom in restriction enzyme choice provides multiple benefits. First, it allows mapping different parts of the same genome. Second, it serves to enhance coverage of genomes of different bacterial species that vary considerably in GC-content. Finally, it is the major optimization parameter when multiple microorganisms must be studied with the same SG pair (i.e. analysis of microbial mixtures or speciation). For example, ApaI can be effectively used to produce DLA-size fragments for the genomes of both E. coli K-12 and S. epidermidis. There are 8 fragments of E. coli K-12 and 3 fragments of S. epidermidis covering 36% and 26% of the total genome, respectively. Note that similarity in lengths of some of these fragments is not an obstacle for microorganism identification, because these fragments carry unique optical traces in DLA.

Two color tagging. Employing probes which bind to different motif sequences on the DNA leads to additional unique maps of the same microbial restriction digest effectively increasing the information obtained by DLA. Maps of three fragments of S. epidermidis obtained with ApaI and tagged with p368A and p58T probes have been generated in separate experiments.

The same result can be achieved in a single experiment, where a pair of tags for different motifs carrying fluorophores with spectrally resolved bands is used. In this case, each fragment produces not one, but two optical traces in different colors; both can be mapped thereby increasing the ability to differentiate and identify molecules. In a SanDI restriction digest of E. coli, the cluster positioned at 65 μm contains four different fragments; however, they include 8 maps—4 maps each for green (p268A) and red (p358Ar) tags. In this case, the maps were obtained by independent analysis of the traces in different colors. As these maps are similar to the theoretical ones, simultaneously targeting two different motifs on the DNA does not interfere with probe binding.

DLA mapping of microbial mixtures. DLA analysis of microbial genomes is not limited to monocultures. In fact, the combined operation of microfluidics, molecule detection, and optical trace analysis is the same for monocultures and mixtures of microorganisms.

Comparison of separate DLA density plots for monocultures and their mixture reveals a range of lengths—from 70 to 100 μm—where ApaI restriction digest of E. coli K-12 and S. epidermidis produces overlapping fragments. Analysis of the molecules in this length range yields seven fragments. Four fragments are identified as E. coli K-12 and 3 fragments are from S. epidermidis. This identification can be done either by using the predicted theoretical maps for sequenced organisms or by using experimental maps previously obtained from monocultures. Fragments from bacteria present in mixtures at concentrations as low as 10% can be detected with our current sorting algorithm.

### Discussion

There are at least three immediate applications of DLA mapping—genotyping, identification of bacteria, and analysis of microbial mixtures. Importantly, the analysis or identification of a vast majority of microorganisms can be done with the same reagents set—a single SG pair. The identification can be done by comparison of the detected maps with a database of templates that can be either calculated from known genomic sequences or measured experimentally as isolates. Even with single motif tagging and with single restriction enzyme, the resolution of DLA mapping is sufficient to differentiate not only between different species, but between multiple strains of a conservative bacterium such as S. aureus.

The ability to discriminate between strains of E. coli is of clinical importance due to the many types of pathogenic strains which often cannot be easily differentiated from commensal flora. Pathogenic E. coli are broadly classified as either intestinal which include strains capable of causing intestinal diarrheal disease including the highly pathogenic enterohemorrhagic E. coli O157:H7 Sakai outbreak strain or extraintestinal which are pathogens associated with disease outside of the intestine including sepsis, meningitis, and urinary tract infections and include the uropathogenic E. coli strain 536. Direct comparison of DLA maps for E. coli 536 and E. coli O157:H7 Sakai with one another show that all fragments are different and that DLA can easily distinguish between the two pathogens (see FIGS. 18 and 19). Furthermore, comparison of DLA maps of non-pathogenic strain E. coli K-12 indicates that each of the pathogenic strains bear little or no resemblance to it and thus would also be easily differentiated.

### Example 3

This Example demonstrates data analysis using data derived from a lab-on-chip (LOC) set up. LOC-DLA is a system designed to perform Direct Linear Analysis (DLA) of genomic DNA from bacteria.

Reagents. Tris-borate-EDTA buffer (TBE, 45 mM Tris, 45 mM boric acid, 1 mM EDTA, pH 8.3), was purchased from Sigma Aldrich (St. Louis, Mo.) as concentrated stock and diluted approximately 20-fold to obtain conductivity of 270 pS. UltraTrol-LN was purchased from Target Discovery, Inc. (Palo Alto, Calif.), and used without further dilution. Solutions of 1 M NaOH, 40% acrylamide-bisacrylamide (19:1), hydroquinone, and 2-hydroxy-2-methylpropiophenone (Darocur 1173) were purchased from Sigma-Aldrich and used as received. The DNA was intercalated with POPO-1 (Invitrogen, Carlsbad, Calif.) at an intercalator-to-basepair ratio of 1:3. Custom PNA tags were synthesized by Panagene (Daejeon, Korea) and labeled with the fluorescent dye ATTO550 (ATTO-TEC, Siegen, Germany) λ Phage DNA (48.5 kb, accession #NC_{—}001416) was purchased from New England Biolabs (Ipswitch, Mass.). BAC 12M9 DNA (185.1 kb, accession #AL080243) was prepared as in Phillips et al., 2005, Nucleic Acid Research 33:5829-5837. All preparations were made using Ultrapure water (18 MΩ, Millipore, Billerica Mass.), filtered through 0.2 μm filter immediately prior to use.

Bacterial culture and sample preparation. Our model targets were Escherichia coli (Gram-negative) and Staphylococcus epidermidis (Gram-positive) bacteria. The complex biological background was modeled by the mixture of Brevibacterium epidermidis, Burkholderia gladioli, Bacillus muralis, Corynebacterium ammoniagenes, Flavobacterium johnsoniae, Paracoccus denitrificans, Rhizobium radiobacter, Stenotrophomonas maltophilia, and Vibrio fischeri.

E. coli K12 MG1655 and S. epidermidis (ATCC 12228, NC_{—}004461) were purchased from ATCC (American Type Culture Collection). For DNA sample preparation, a single colony of either bacterium was picked and cultured in 5 ml Luria-Bertani or trypticase soy broth, respectively. Samples were cultured overnight at 37° C. with agitation. For detection of targets in complex biological background, 10⁴ E. coli cells and 10⁵ S. epidermidis cells were added to a frozen complex background mixture. This mixture consisted of Brevibacterium epidermidis 19.2%, Burkholderia gladioli 9.3%, Bacillus muralis 6.1%, Corynebacterium ammoniagenes 5.5%, Flavobacterium johnsoniae 8.6%, Paracoccus denitrificans 8.8%, Rhizobium radiobacter 12.4%, Stenotrophomonas maltophilia 15.4%, Vibrio fischeri 9.2% (by cell counting). The growth conditions of the background components are presented in Table S1. Aliquots of 1.9×10⁶ cells (9.5 ng of DNA) of this mixture were prepared and frozen at −80° C. for subsequent use. This mixture of bacteria was selected as a representative biological background as found in air samples, and consists primarily of 4 phyla; Actinobacteria, Bacteroides, Finnicutes, and Proteobacteria.

DLA data acquisition. DLA measurements were performed as described in White et al., 2009, Clin. Chem., 55:2121-2129; Burton et al., 2010, Lap Chip, 10:843-851; and Larson et al., 2006, Lab Chip, 6:1187-1199. Briefly, DNA molecules were stretched to near contour length by accelerated flow formed by a two-dimensional funnel. Once extended, the DNA molecule passed through three spots of focused laser light. In two spots, light with 445 nm wavelength excited fluorescence of the intercalated DNA backbone, and in a third spot, light with 532 nm wavelength excited the ATTO550 fluorophores of bisPNA tags hybridized to specific sites along the DNA molecule. The resultant fluorescence from the three spots was confocally detected in three corresponding detection channels. The fluorescence signal in the two channels detecting DNA backbone fluorescence provided information about the velocity and length of individual DNA molecules, and the signal generated by specific tags was used to map their locations onto the extended DNA backbone.

DLA was performed using an acquisition system that provided fully automated positioning of the LOC-DLA device relative to the illumination and detection optics. As a control, DLA of the DNA samples was also performed using a simple, fluidics-only chip that lacked concentration and fractionation functions. This device has been described in White et al., 2009, Clin. Chem., 55:2121-2129 and Burton et al., 2010, Lap Chip, 10:843-851. These data were used to evaluate the effect of sample concentration and fractionation on information throughput in LOC-DLA.

DLA data analysis. In the first stage of DLA data analysis, software was used to identify single molecule traces. (Phillips et al., 2005, Nucleic Acid Research, 33:5829-5837; and Larson et al., 2006, Lab Chip, 6:1187-1199.) Fluorescent signals in the tag channel were correlated with corresponding events in the two intercalator signal channels, and these molecule traces were exported for further analysis. This analysis also provided information about the length and velocity distributions of observed fragments.

Interpretation of the site-specific fluorescent tagging was achieved by either clustering similar fragments, or evaluating single molecule fluorescence traces by comparing them to a data base of empirical or theoretically predicted templates. The clustering algorithm, as described herein, was used for the identification of simple mixtures of bacteria. Template-based matching was required for analysis of complex mixtures of bacteria, where the target of interest was mixed with a large proportion of background DNA molecules.

Detection of DNA fragments by template-based classification of optical traces of single molecules. Template-based fragment classification is a novel application of the DLA detection technology, and allows for sensitive detection of DNA fragments in the presence of a large excess of non-target DNA. For this classification method, traces of individual molecules are first identified in the raw data and exported by the software discussed above. Similarly to data analysis by the clustering software, poorly stretched or overlapping molecules are identified by their backbone traces and excluded from the data set.

The subsequent classification is based on a calculation of the likelihood that each of the individual traces could originate from one of the species from a target database that contains a collection of optical patterns (traces, templates), each of which is produced in average by molecules of specific restriction fragments from every considered target organism in the DLA length range. The average template patterns are generated either by theoretical calculation, based on known sequences and binding probabilities, or experimentally produced by the DLA analysis and clustering of non-sequenced samples.

The likelihood calculation algorithm is based on a statistical model of the expected distribution of photons measured along a target DNA restriction fragment. The assumed log-normal distribution accounts for experimental noise and stochastic events at the single molecule level.

In order to simplify comparison of molecules to templates, all optical traces (both measured ones for single molecules and average ones for templates) are interpolated to be represented by the same number of intervals (200). Hence, measured optical traces are represented by 200 values of photon counts tᵢ (i=1 . . . 200). The database template average intensity μᵢ for each interval is used to calculate the probability p(tᵢ, μᵢ) of observing intensity tᵢ in an interval i with mean μᵢ. Assuming that the intervals are independent, we present the probability of observing a specific trace originating from a given target template as the product of partial probabilities from intervals: P_{trace}=πᵢp(tᵢ, μᵢ). The full probability of observing a specific trace also includes the Gaussian term G_{L}, modeling the length distribution of stretched molecules: P(m|T)=G_{L}·P_{trace}, where P(m|T)—is the probability that trace m originates from a target fragment T. Since the probabilities P have very small values, we introduce the distances from templates to traces, where a distance is a negative logarithm of probability P:D=−log(P(m|T)).

The step of the classification process is the calculation of distances D from each single molecule trace to each database fragment. After calculating the distances, each of the measured molecules is assigned to a DNA fragment (“template”) to which it has the shortest distance. As a result of this process, several fragments from the database have one or more molecules associated with them. We assume that some of the single molecules may be misclassified due to various reasons: incomplete stretching or tagging, presence of nonspecific tags, shot noise in tag fluorescence channel, lack of proper templates in the database, etc. Therefore, the fragments that have molecules associated with them are merely the potential candidates for detection, and we perform post-classification analysis evaluating each of these groups of molecules.

Confidence of classification and identification for each molecule is correlated with the difference of distances ΔD=D_{B}−D_{T}, where D_{T} is the distance from the template to which the molecule has been classified (“target”) and D_{B} is the distance to the next closest template (“background”). The difference in distances ΔD corresponds to relative likelihood (or log-likelihood) that the molecule has originated from the fragment T rather than some other fragment B:

$$Δ D = {D}_{B} - {D}_{T} ∝ log [ \frac{P ( {m}_{i} \vert T )}{P ( {m}_{i} \vert B )} ] \qquad ( 1 )$$

For ambiguous molecules, the ratio of probabilities is close to 1 and log-likelihood is close to 0. The log-likelihood value increases with the confidence in classification of a molecule. We characterize each resultant group of classified molecules by two parameters: their quantity expressed as a fraction of the total number of molecules submitted for classification (after initial filtering), and the average log-likelihood, which is the average of ΔD of all molecules in the group.

The data may be presented as a scatter plot of average log-likelihood vs. fraction of observed molecules. In this specific example we have introduced digitally randomized templates that are known to not match sample targets. These serve as null templates that allow us to model noise in the experiment and analysis. This, in turn allows for correction in the log-likelihood scale in order to set the threshold for positive detection above the background of misclassified molecules. The p-values have been calculated using the distribution of log-likelihood for null templates.

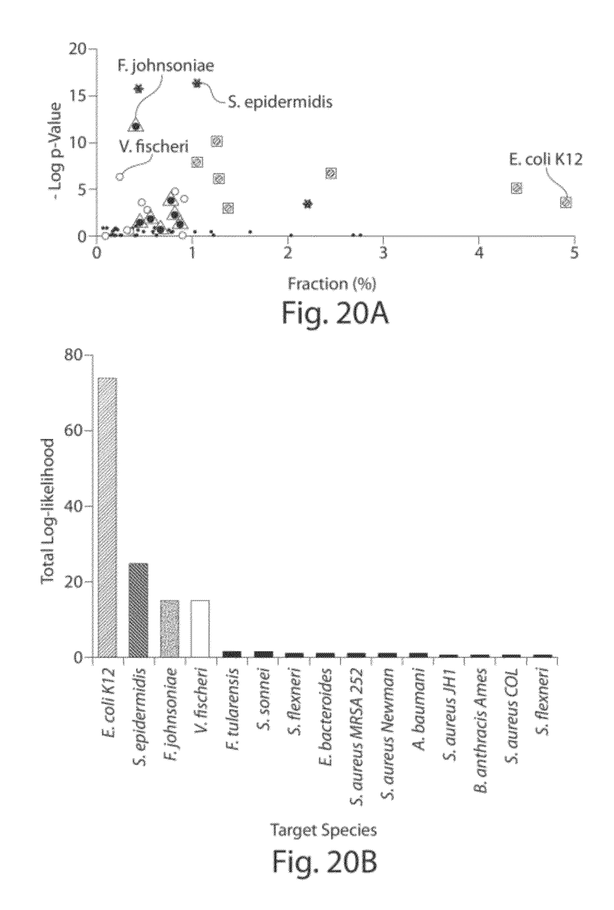

Finally, for each fragment we can calculate the product of the average log-likelihood and relative quantity. We call this value the total log-likelihood of detection. (See FIG. 20B.) Since both the quantity of detected molecules and the average log-likelihood are higher for targets truly present in the sample, their product highlights the species identified in the mixture.

Bacterial identification in complex mixture. To assess the capability of LOC-DLA to implement DLA for detection and identification of bacterial targets in mixtures, we prepared a representative model of a complex biological background, as expected for an environmental air sample. Our model targets, E. coli (10⁴ cells corresponding to 50 pg of DNA) and S. epidermidis (10⁵ cells corresponding to 250 pg of DNA), were spiked into an excess of the model background mixture at final concentrations of 1% and 4% by DNA mass, respectively. The DNA was extracted, purified, digested, and tagged using a standard sample preparation protocol, and the entire sample containing 10 ng of DNA was processed on LOC-DLA.

The single molecule classification of the resulting data from DLA analysis demonstrated confident detection of both E. coli and S. epidermidis, as well as two additional components of the complex background: F. johnsoniae and V. fischerii (FIG. 20). Several genomic fragments of each bacteria were reliably detected (FIG. 20A). The detection confidence varied for different fragments, depending primarily on the “uniqueness” of the pattern generated by a fragment. Two S. epidermidis fragments with long length and rich patterns demonstrated extremely high confidence of detection with p-values below 10⁻¹⁶. Because the restriction enzyme and the probe were optimized for specific target detection, the proportion of detected E. coli fragments was highest even though it was a minor component of the mixture. Several background bacteria had GC-rich genomes, which were selectively degraded to very small fragments by using the ApaI restriction enzyme with the recognition sequence GGGCCC. These fragments were rejected by the DNA prism and therefore were not measured, thus increasing the detection efficiency for the targets of interest.

The potential to identify multiple fragments from each bacterial genome increases the confidence of detecting a target of interest. This is represented by the Total Log-Likelihood (TLL) metric (FIG. 20B) In this experiment, observed DNA fragments were compared against a pattern database including 98 DNA fragments ranging in length from 160 to 300 kb. These represent a test library of 40 different strains from 22 distinct species. In the FIG. 20B, only the 15 bacteria from the database that generated “hits” against the detected fragments are presented. E. coli, S. epidermidis, F. johnsoniae, and V. fischeri all had significantly higher TLL than all other potential hits; no other organism in the database appeared as a significant false-positive detection event. Other components of the complex biological background sample were not included in the test database, and therefore were not detected in this experiment.

This Example is representative of hundreds of repeated operations of the LOC-DLA system under a variety of test samples and conditions. In integrated operation with the sample preparation reactor, LOC-DLA could be used to consistently detect DNA fragments from 5×10³ target cells in a mixture of 6×10⁴ to 6×10⁶ background organisms (data not shown).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

All patent applications and patents referred to herein are incorporated by reference herein in their entirety. In case of conflict, the present specification, including definitions, will control.

What is claimed is:

1. A method comprising
determining extent of similarity between an observed trace from an observed nucleic acid and each of a plurality of template traces, each template trace representing an average trace for a class of nucleic acids, and
identifying the class of nucleic acids to which the observed nucleic acid belongs using a classification algorithm,
wherein each trace is an intensity versus time trace or an intensity versus distance trace for a nucleic acid.

2. The method of claim 1, wherein the template trace is an average trace of a plurality of previously acquired traces.

3. The method of claim 1, wherein the template trace is an average theoretical trace.

4. The method of claim 1, wherein the observed trace is from an observed nucleic acid labeled with a sequence non-specific backbone stain and a sequence-specific probe.

5. The method of claim 1, further comprising, prior to determining extent of similarity, excluding observed traces having higher than expected intensities.

6. The method of claim 1, further comprising, prior to determining extent of similarity, excluding observed traces having higher than expected backbone stain intensities.

7. The method of claim 1, further comprising, prior to determining extent of similarity, applying an acceleration correction to the observed trace.

8. The method of claim 7, wherein the acceleration correction is a correction that results in symmetry between head-first and tail-first observed traces.

9. The method of claim 1, further comprising, prior to determining extent of similarity, applying a stretching coefficient to the observed trace.

10. The method of claim 9, wherein the stretching coefficient is determined using a standard nucleic acid of known length that is labeled with a sequence non-specific backbone stain only.

11. The method of claim 1, wherein the classification algorithm is a statistical model of expected distribution of photons measured along a target nucleic acid.

12. The method of claim 1, wherein the observed nucleic acid is obtained from a mixture of nucleic acids.

13. The method of claim 12, wherein the mixture of nucleic acids is obtained from a mixture of pathogens.

14. The method of claim 1, wherein the observed nucleic acid is a restriction fragment.

15. The method of claim 1, wherein the observed nucleic acid is about 50-500 kb in length.

16. The method of claim 1, wherein the observed nucleic acid is about 100-300 kb in length.

17. The method of claim 4, wherein the sequence-specific probe is a bisPNA.

18. The method of claim 17, wherein the bisPNA probe is a doubly labeled ATTO550₂-c probe, ATTO550₂-c(-K) probe or ATTO550₂-cLL probe.
